(19) United States
(12) Patent Application Publication
(10) Pub. No.: US 2007/0252892 A1
(43) Pub. Date: Nov. 1, 2007

(54) Moving-State Detecting Apparatus and Moving-State Detecting System

(76) Inventors: Manabu Fujita, Tokyo (JP); Toshiaki Shigemori, Tokyo (JP); Seiichiro Kimoto, Tokyo (JP); Ayako Nagase, Tokyo (JP); Akira Matsui, Tokyo (JP); Kazutaka Nakatsuchi, Tokyo (JP)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/632,559

(22) PCT Filed: Jul. 14, 2005
(86) PCT No.: PCT/JP05/13082

§ 371 Date: Feb. 26, 2007

(30) Foreign Application Priority Data
Jul. 16, 2004 (JP) 2004-210528
Jul. 16, 2004 (JP) 2004-210529

(51) Int. Cl. A62B 1/04

(52) U.S. Cl. 348/65; 348/E05.035

(57) ABSTRACT

To achieve a moving-state detecting apparatus and a moving-state detecting system that detect a moving state of a body-insertable apparatus such as a capsule endoscope within a subject, a body-insertable apparatus (2) includes a sensor signal transmitter that transmits a sensor signal which is attenuated according to a propagation distance. A moving-state detecting apparatus (3) includes receiving antennas (7a to 7h) that receive sensor signals, and a moving-state calculator that calculates a moving state of the body-insertable apparatus (2), based on received strength of sensor signals received by the receiving antennas (7a to 7h).

### TECHNICAL FIELD

The present invention relates to a moving-state detecting apparatus and a moving-state detecting system that detect a moving state of a body-insertable apparatus that moves inside a subject and outputs a sensor signal which is attenuated according to a distance inside the subject.

### BACKGROUND ART

In recent years, a swallowable capsule endoscope has been proposed in the field of the endoscope. This capsule endoscope has an imaging function and a radio communication function. The capsule endoscope has such a function that after the capsule endoscope is swallowed from the mouth of a subject for the purpose of observation (examination), the capsule endoscope moves inside body cavities, for example, internal organs such as a stomach and a small intestine following peristaltic motions of the organs, and sequentially picks up images, until the capsule endoscope is naturally discharged.

While the capsule endoscope moves inside the body cavity, image data that is picked up inside the body by the capsule endoscope is sequentially transmitted to the outside by radio communication, and is stored in a memory provided at the outside. By carrying a receiver having a radio communication function and a memory function, the subject can freely move after swallowing the capsule endoscope until it is discharged. After the capsule endoscope is discharged, a doctor or a nurse can diagnose by displaying the images of the organ on a display, based on the image data stored in the memory (see, for example, Patent Document 1).

According to the conventional capsule endoscope, an imaging interval of images of the stomach, the small intestine or the like inside the subject is determined by taking into consideration a data amount of images acquired by the imaging, a transmission capacity of the radio communication function, and power consumption of the imaging function and the like. For example, according to the conventional capsule endoscope, the imaging interval is set in advance as two image pickups per one second, and the imaging is repeated at this imaging interval until the capsule endoscope is discharged to the outside of the subject.

Patent Document 1: Japanese Patent Application Laid-open No. 2003-19111

### DISCLOSURE OF INVENTION

### Problems to be Solved by the Invention

However, the conventional capsule endoscope has a problem in that imaging of the same area is repeated due to variation of a moving speed of the capsule endoscope inside the subject, because the imaging interval is maintained at a constant value. This problem is explained in detail below.

A moving state of the capsule endoscope inside the subject is not constant, and the capsule endoscope has a characteristic of staying in the stomach for a relatively long time, while quickly moving within the esophagus, for example. The moving state of the capsule endoscope is different between tested bodies, and is also different for the same subject, depending on the physical condition or the like.

Therefore, when an imaging operation is performed at a constant interval as in the conventional practice, the number of image data acquired is small in the area where the capsule endoscope moves at a fast speed, whereas, substantially the same image is picked up plural times in the area where the capsule endoscope moves at a low speed. The capsule endoscope needs to be made small to the extent that the capsule endoscope can be inserted into the subject, and has a configuration in which the capsule endoscope is driven by power supplied from a built-in small-capacity battery. Therefore, there is a limit to the number of images picked up, and it is necessary to eliminate the waste of picking up images plural times in substantially the same area.

On the other hand, in order to change the imaging interval according to the moving state of the capsule endoscope inside the subject, the moving state of the capsule endoscope needs to be understood in advance. However, at present, no effective proposal is made regarding the technique of detecting a moving state of the capsule endoscope inside the subject while avoiding the increase in power consumption.

The present invention has been achieved in view of the above problems, and it is an object of the present invention to provide a moving-state detecting apparatus and a moving-state detecting system that can detect a moving state of a body-insertable apparatus such as a capsule endoscope in a subject.

### Means for Solving Problems

In order to achieve the object by solving the above problems, a moving-state detecting apparatus according to claim 1 detects a moving state of a body-insertable apparatus that moves within a subject, and outputs a sensor signal which is attenuated according to a propagation distance inside the subject, the moving-state detecting apparatus including a receiving antenna unit that receives the sensor signal; and a moving-state calculator that calculates a moving state of the body-insertable apparatus, based on received strength of the sensor signal received by the receiving antenna unit.

In the moving-state detecting apparatus according to the invention as set forth in claim 2, a plural number of the receiving antenna units are disposed, and the moving-state calculator includes an antenna selector that selects one or more receiving antenna units from a plural number of the receiving antenna units at each predetermined time interval, based on received strength of the sensor signal; a timing unit that measures a time during which the antenna selector continuously selects the same receiving antenna unit; and a determining unit that determines a moving state of the body-insertable apparatus, based on a time measured by the timing unit.

In the invention of claim 2, the antenna selector that selects a part of receiving antennas from among plural receiving antennas is provided. At the same time, there is also provided the state determining unit that determines a moving state of the body-insertable apparatus based on a time during which the antenna selector continuously selects the same receiving antenna unit. Therefore, a moving state can be determined based on a simple configuration.

In the moving-state detecting apparatus according to the invention as set forth in claim 3, when the time measured by the timing unit is equal to or above a predetermined threshold value, the determining unit determines that a moving state of the body-insertable apparatus is in a low-speed state.

In the moving-state detecting apparatus according to the invention as set forth in claim 4, the body-insertable apparatus has a function of transmitting a radio signal as the sensor signal, and the moving-state calculator calculates a moving state of the body-insertable apparatus, based on the strength of a radio signal from the body-insertable apparatus received by the receiving antenna unit.

In the moving-state detecting apparatus according to the invention as set forth in claim 5, the moving-state calculator calculates a moving state of the body-insertable apparatus, based on a change rate of received strength of the sensor signal received by the receiving antenna unit.

In the moving-state detecting apparatus according to the invention as set forth in claim 6, a plural number of the receiving antenna units are disposed, and the moving-state calculator calculates a moving state of the body-insertable apparatus, based on a change of received strength received by each of the plural receiving antenna units.

In the moving-state detecting apparatus according to the present invention as set forth in claim 7, the moving-state calculator includes a position calculator that calculates a position of the body-insertable apparatus, based on received strength received by the receiving antenna unit; and a state determining unit that determines a moving state of the body-insertable apparatus, based on a change rate of a position of the body-insertable apparatus calculated by the position calculator.

According to the invention as set forth in claim 7, the state determining unit determines a moving state of the body-insertable apparatus, based on a calculated position. With this arrangement, a doctor or a nurse can easily understand a moving state of the body-insertable apparatus inside the subject.

In the moving-state detecting apparatus according to the invention as set forth in claim 8, the state determining unit calculates a change rate, based on a position of the calculating apparatus calculated at different plural times by the position calculator.

In the moving-state detecting apparatus according to the invention as set forth in claim 9, the antenna selector selects a predetermined number of the receiving antenna units in order of the descending received strength, and the timing unit measures a time during which a size relationship of received strength of the receiving antenna units that are selected simultaneously remains the same, as a continuation selection time.

A moving-state detecting system as set forth in claim 10 includes a body-insertable apparatus that is inserted into a subject, acquires predetermined intra-subject information, and performs radio-transmission of a radio signal including the intra-subject information to the outside; and a moving-state detecting apparatus that receives the radio signal transmitted from the body-insertable apparatus, and calculates a moving state of the intra-subject information, wherein the body-insertable apparatus includes a sensor signal transmitter that transmits a sensor signal which is attenuated according to a propagation distance, and the moving-state detecting apparatus includes a receiving antenna unit that receives the sensor signal, and a moving-state calculator that calculates a moving state of the body-insertable apparatus, based on received strength of the sensor signal received by the receiving antenna unit.

In the moving-state detecting system according to the invention as set forth in claim 11, the moving-state detecting apparatus includes a plural number of the receiving antenna units, and the moving-state calculator includes an antenna selector that selects one or more receiving antenna units from the plural number of the receiving antenna units, based on received strength of the sensor signal; a timing unit that measures a time during which the antenna selector continuously selects the same receiving antenna unit; and a determining unit that determines a moving state of the body-insertable apparatus, based on a time measured by the timing unit.

A moving-state detecting system as set forth in claim 12 includes a body-insertable apparatus that is inserted into a subject, acquires predetermined intra-subject information, and performs radio-transmission of a radio signal including the intra-subject information to the outside; and a moving-state detecting apparatus that receives the radio signal transmitted from the body-insertable apparatus, and calculates a moving state of the intra-subject information, wherein the body-insertable apparatus includes a sensor signal transmitter that transmits a sensor signal which is attenuated according to a propagation distance, and the moving-state detecting apparatus includes a receiving antenna unit that receives the sensor signal, a position calculator that calculates a position of the body-insertable apparatus, based on received strength received by the receiving antenna unit, and a state determining unit that determines a moving state of the body-insertable apparatus, based on a change rate of a position calculated by the position calculator.

In the moving-state detecting system as set forth in claims 13 and 14, the moving-state detecting apparatus further includes an intra-subject information acquiring unit that acquires predetermined intra-subject information inside the subject, the sensor signal transmitter transmits a radio signal including the intra-subject information as a sensor signal, and the moving-state detecting apparatus further includes an information extracting unit that extracts the intra-subject information from a radio signal received via the receiving antenna unit.

In the moving-state detecting system according the invention as set forth in claims 15 and 16, the moving-state detecting system further includes a display device that displays the intra-subject information and a moving state of the body-insertable apparatus near a position where at least the intra-subject information is acquired.

### EFFECT OF THE INVENTION

The moving-state detecting apparatus and the moving-state detecting system according to the present invention include the moving-state calculator that calculates the moving state of the body-insertable apparatus, based on received strength of the sensor signal (radio signal) which is attenuated according to the propagation distance. For example, there is an effect that a moving state of the body-insertable apparatus can be detected by calculating a change of a distance between the body-insertable apparatus and the receiving antenna unit based on a change of the received strength.

Further, according to the moving-state detecting apparatus and the moving-state detecting system of the present invention, the state determining unit determines the moving state of the body-insertable apparatus, based on the calculated position. With this arrangement, there is an effect that a doctor or a nurse can easily understand a manner of moving of the body-insertable apparatus inside the subject.

The moving-state detecting apparatus and the moving-state detecting system according to the present invention include the antenna selector that selects a part of receiving antennas from among plural receiving antennas. At the same time, the moving-state detecting apparatus and the moving-state detecting system include the state determining unit that determines the moving state of the body-insertable apparatus based on a time length during which the antenna selector continuously selects the same receiving antenna unit. Therefore, there is an effect that the moving state can be determined based on a simple configuration.

### BRIEF DESCRIPTION OF DRAWINGS

FIG. 1 is a schematic diagram showing an overall configuration of a moving-state detecting system according to a first embodiment;

FIG. 2 is a block diagram showing a configuration of a capsule endoscope provided in the moving-state detecting system according to the first embodiment;

FIG. 3 is a block diagram showing a configuration of a moving-state detecting apparatus provided in the moving-state detecting system according to the first embodiment;

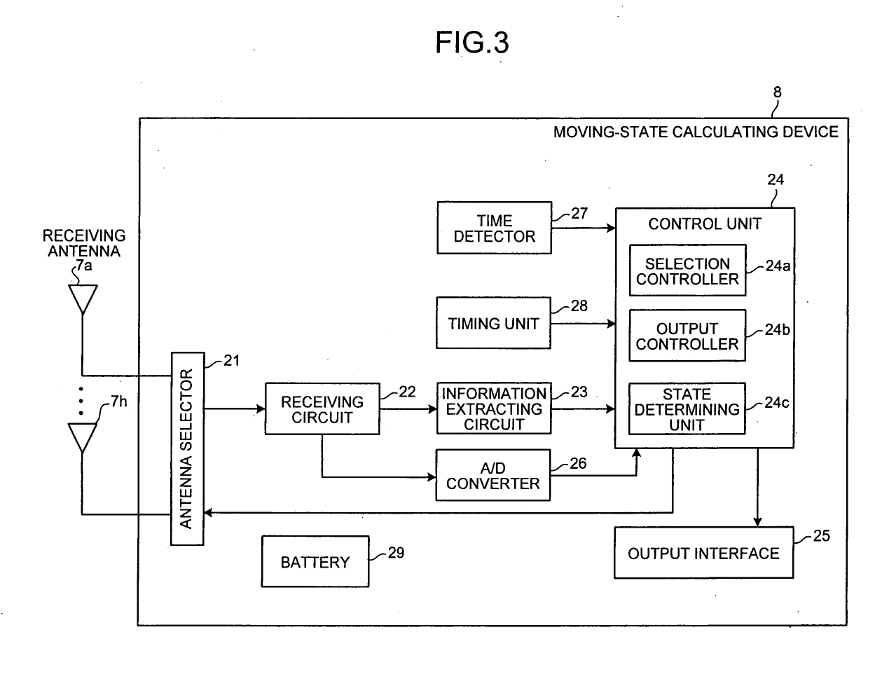

FIG. 4 is a flowchart for explaining an antenna selecting operation in the moving-state detecting system according to the first embodiment;

FIG. 5 is a flowchart for explaining a moving-state determining operation in the moving-state detecting system according to the first embodiment;

FIG. 6 is a block diagram showing a configuration of a moving-state detecting apparatus provided in a moving-state detecting system according to a second embodiment;

FIG. 7 is a flowchart for explaining a moving-state determining operation in the moving-state detecting system according to the second embodiment;

FIG. 8 is a block diagram showing a configuration of a moving-state detecting apparatus provided in a moving-state detecting system according to a third embodiment;

FIG. 9 is a flowchart for explaining a moving-state determining operation in the moving-state detecting system according to the third embodiment;

FIG. 10 is a schematic diagram for explaining advantages of the moving-state detecting system according to the third embodiment;

FIG. 11 is a block diagram showing a configuration of a moving-state calculating device provided in a moving-state detecting system according to a fourth embodiment;

FIG. 12 is a flowchart showing a process performed by a selection controller in an operation of selecting a position deriving antenna according to the fourth embodiment;

FIG. 13 is a schematic diagram for explaining a position calculating operation performed by a position calculator according to the fourth embodiment;

FIG. 14 is a flowchart showing an operation of a state determining unit to determine a moving state according to the fourth embodiment;

FIG. 15 is a schematic diagram showing one example of a display mode on a screen of a display device according to the fourth embodiment;

FIG. 16 is a block diagram showing a configuration of a moving-state calculating device provided in a moving-state detecting system according to a fifth embodiment; and

FIG. 17 is a flowchart for explaining a determining operation performed by a state determining unit according to the fifth embodiment.

### EXPLANATIONS OF LETTERS OR NUMERALS

1 Subject
2 Capsule endoscope
3 Moving-state detecting apparatus
4 Display device
5 Portable recording medium
7a to 7h Receiving antenna
8 Moving-state calculating device
9 Intra-subject information acquiring unit
10 Radio transmitting unit
11 LED
12 LED driving circuit
13 CCD
14 CCD driving circuit
16 Transmitting circuit
17 Transmitting antenna unit
18 System control circuit
19 Capacitor
21 Antenna selector
22 Receiving circuit
23 Information extracting circuit
24 Control unit
24a Selection controller
24b Output controller
24c State determining unit
25 Output interface
26 A/D converter
27 Time detector
28 Timing unit
29 Battery
31 Moving-state calculating device
32 Strength storage unit
33 Control unit
33a Strength change rate calculator
33b State determining unit
35 Moving-state calculating device
36 Control unit
36a Strength change rate calculator
36b State determining unit
108 Moving-state calculating device
121 Antenna selector
122 Receiving circuit
123 Information extracting circuit
124 Control unit
124a Selection controller
124b Output controller
124c Position calculator
124d State determining unit
125 Output interface
126 Converter
127 Timing unit
128 Capsule position storage unit
129 Battery
132 Intra-subject image
133 Subject image
134 Passing route
134a Normal area
134b Low-speed area
135 Imaging position
136 Moving-state calculating device
137 Control unit
137d State determining unit
138 Selected antenna storage unit

### BEST MODE(S) FOR CARRYING OUT THE INVENTION

A moving-state detecting apparatus and a moving-state detecting system will be explained below as best modes for carrying out the invention (hereinafter, simply referred to as “embodiments”). Note that the drawings are schematic, and that a relationship between a thickness and a width of each part, and a rate of a thickness of each part are different from actual data. Needless to mention, a size relationship and rates may be different between drawings.

### First Embodiment

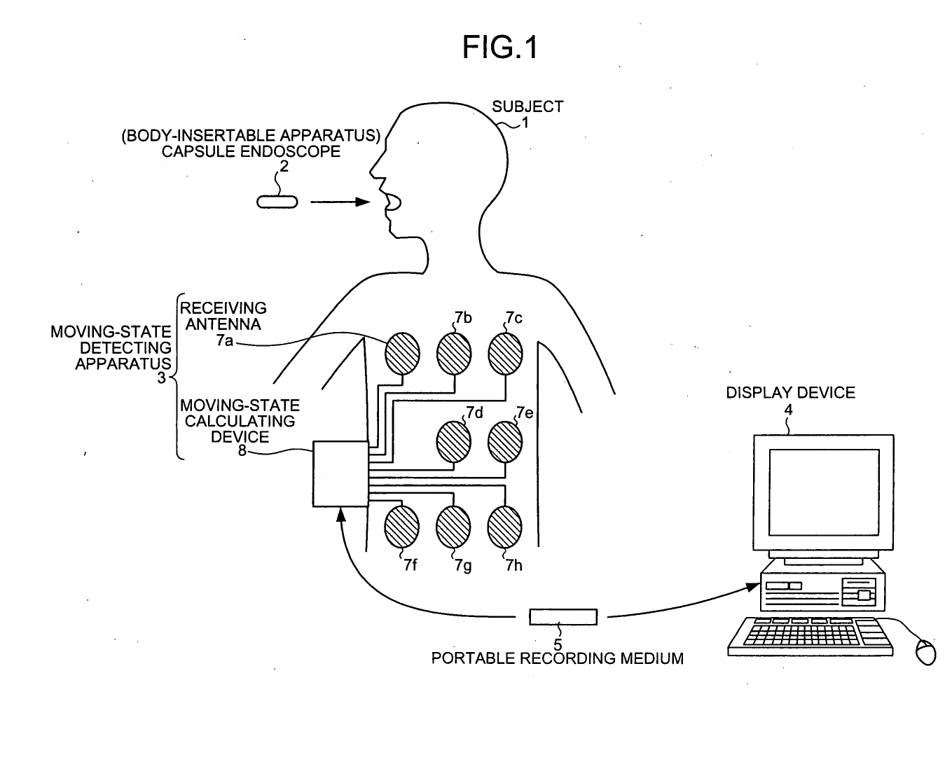

First, a moving-state detecting system according to a first embodiment is explained. FIG. 1 is a schematic diagram showing an overall configuration of a moving-state detecting system according to a first embodiment. As shown in FIG. 1, the moving-state detecting system according to the first embodiment includes a capsule endoscope 2 that is inserted into a subject 1, and functions as one example of a body-insertable apparatus, a moving-state detecting apparatus 3 that performs operations such as detection of a moving state of the capsule endoscope 2 inside the subject 1; a display device 4 that displays a moving state and the like of the capsule endoscope 2 detected by the moving-state detecting apparatus 3; and a portable recording medium 5 that delivers information between the moving-state detecting apparatus 3 and the display device 4.

The display device 4 serves to display a moving state and the like of the capsule endoscope 2 acquired by the moving-state detecting apparatus 3, and has a configuration of a workstation or the like that displays an image based on data acquired by the portable recording medium 5. Specifically, the display device 4 can be configured to directly display an image and the like using a CRT display, a liquid-crystal display, etc., or can be configured to output an image and the like to other medium as in a printer.

The portable recording medium 5 is attachable to and detachable from a moving-state calculating device 8 described later and the display device 4, and has a configuration that enables outputting and recording of information when the portable recording medium 5 is attached to the moving-state calculating device 8 or the display device 4. Specifically, while the capsule endoscope 2 is moving through the body cavity of the subject 1, the portable recording medium 5 is mounted on the moving-state calculating device 8, and records information concerning a position of the capsule endoscope 2. After the capsule endoscope 2 is discharged from the subject 1, the portable recording medium 5 is taken out from the moving-state calculating device 8, and is mounted on the display device 4. The display device 4 reads the recorded data. When a portable recording medium 5 such as a Compact Flash (registered trademark) memory or the like is used to deliver data between the moving-state calculating device 8 and the display device 4, the subject 1 can move freely while the capsule endoscope 2 is moving inside the subject 1, unlike when the moving-state calculating device 8 and the display device 4 are connected to each other by wire.

The capsule endoscope 2 functions as one example of a body-insertable apparatus in the claims, and is inserted into the subject 1 and is used to acquire intra-subject information and transmit a radio signal including the acquired intra-subject information to the outside. As described later, the radio signal transmitted from the capsule endoscope 2 not only function as a transmission signal of the intra-subject information but also functions as one example of a sensor signal in the claims.

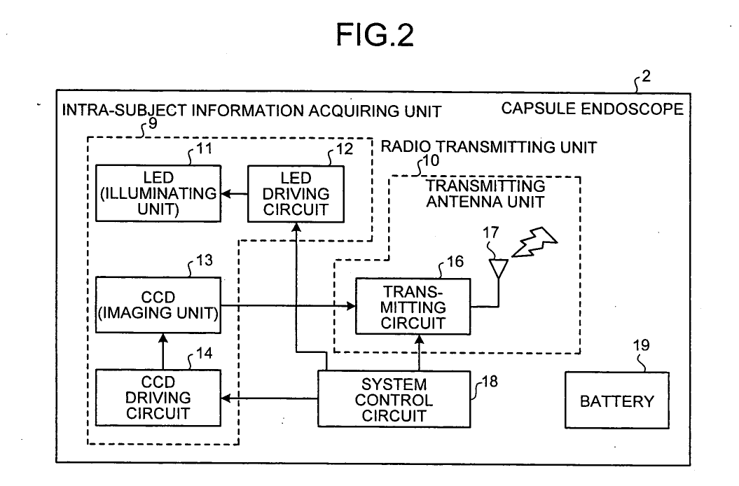

FIG. 2 is a block diagram showing a configuration of the capsule endoscope 2. As shown in FIG. 2, the capsule endoscope 2 includes an intra-subject information acquiring unit 9, a radio transmitting unit 10 that transmits a radio signal including the intra-subject information acquired by the intra-subject information acquiring unit 9, a system control circuit 18 that controls the driving state of the intra-subject information acquiring unit 9 and the radio transmitting unit 10, and a capacitor 19 that supplies driving power to the radio transmitting unit 10 and the like.

The intra-subject information acquiring unit 9 obtains intra-subject information as information concerning the inside of the subject 1, while the capsule endoscope 2 is in the subject 1. In the first embodiment, the intra-subject information acquiring unit 9 acquires an intra-subject image as the intra-subject information, and the intra-subject information acquiring unit 9 includes constituent elements that are necessary to acquire the intra-subject image.

Specifically, the intra-subject information acquiring unit 9 includes an LED 11 that functions as one example of an illuminating unit in the claims, and an LED driving circuit 12 that controls a driving state of the LED 11, a CCD 13 that functions as one example of an imaging unit in the claims, and a CCD driving circuit 14 that controls a driving state of the CCD 13.

The radio transmitting unit 10 transmits a radio signal that includes the intra-subject information acquired by the intra-subject information acquiring unit 9, and that functions as one example of a sensor signal in the claims. Specifically, the radio transmitting unit 10 includes a transmitting circuit 16 that generates a radio signal by performing a necessary predetermined process to the intra-subject image acquired by the CCD 13, and a transmitting antenna unit 17 that transmits a radio signal generated by the transmitting circuit 16.

Next, the moving-state detecting apparatus 3 is explained. As shown in FIG. 1, the moving-state detecting apparatus 3 includes receiving antennas 7a to 7h, and the moving-state calculating device 8 that is connected to the receiving antennas 7a to 7h.

The receiving antennas 7a to 7h receive radio signals transmitted from the capsule endoscope 2. Specifically, the receiving antennas 7a to 7h include loop antennas, and a fixing unit that fixes the loop antennas to the body surface of the subject 1.

The moving-state calculating device 8 includes a mechanism that selects a receiving antenna 7 which is suitable for reception, from the receiving antennas 7a to 7h, and a mechanism that acquires intra-subject information (intra-subject image information in the first embodiment) from a radio signal received by the selected receiving antenna 7. The moving-state calculating device 8 further includes a mechanism that understands a moving state of the capsule endoscope 2, based on a selection mode of the receiving antennas 7a to 7h.

First, as a mechanism that selects a receiving antenna 7 which is suitable for reception, from the receiving antennas 7a to 7h, the moving-state calculating device 8 includes an antenna selector 21 that outputs only a radio signal received via the selected receiving antenna 7, out of the radio signals received by the receiving antennas 7a to 7h, respectively, a receiving circuit 22 that performs a predetermined process to the radio signal input via the antenna selector 21, and an A/D converter 26 that analog-to-digital converts a received strength signal output from the receiving circuit 22. A selection controller 24a that performs a predetermined control in the antenna selecting operation is provided within a control unit 24.

The antenna selector 21 selects a receiving antenna 7 which is suitable to receive a radio signal transmitted from the capsule endoscope 2, from the receiving antennas 7a to 7h. As shown in FIG. 1, the receiving antennas 7a to 7h are disposed at different positions on the body surface of the subject 1. When the capsule endoscope 2 moves within the subject 1, a distance from each of the antennas 7a to 7h to the capsule endoscope 2 changes. Therefore, in the first embodiment, the antenna selector 21 selects a receiving antenna 7 which is most suitable to receive the radio signal transmitted from the capsule endoscope 2, from the plural receiving antennas 7a to 7h. Specifically, the antenna selector 21 has a function of selecting a receiving antenna 7, based on the control of the selection controller 24a provided in the control unit 24.

The receiving circuit 22 performs a predetermined process to the radio signal received via any one of the receiving antennas 7a to 7h. Specifically, the receiving circuit 22 has a function of performing a process necessary to extract intra-subject information described later, and outputting a signal corresponding to the received strength of the radio signal, such as RSSI (Received Signal Strength Indicator), in a format of an analog signal, to the A/D converter 26.

The selection controller 24a is provided within the control unit 24, and is used to select an antenna based on received strength in each of the receiving antennas 7a to 7h. Specifically, the selection controller 24a selects a receiving antenna 7 most suitable for reception based on information concerning received strength input via the A/D converter 26, and controls the antenna selector 21 to output only the radio signal received via the selected receiving antenna 7, to the receiving circuit 22. A specific antenna selection algorithm of the selection controller 24a is explained in detail later.

As the mechanism that acquires intra-subject information, the moving-state calculating device 8 includes an information extracting circuit 23 that extracts intra-subject information, i.e., intra-subject image information in the first embodiment, from a radio signal subjected to a predetermined process, via the antenna selector 21 and the receiving circuit 22, and an output interface 25 that outputs the extracted intra- subject image and the like to the portable recording medium 5. An output controller 24b that controls the output such as the acquired intra-subject information is provided in the control unit 24.

The output interface 25 outputs information output from the control unit 24, to the portable recording medium 5. Specifically, the output interface 25 has a physical configuration to which the portable recording medium 5 can be mounted, and has a function of writing information output from the control unit 24 to the portable recording medium 5, based on the control of the output controller 24b.

Further, the moving-state calculating device 8 has a time detector 27 having a function of a timepiece, and a timing unit 28 having a timing function, as a mechanism that determines a moving state of the capsule endoscope 2 within the subject 1 based on the antenna selection mode. A state determining unit 24c that determines a moving state of the capsule endoscope 2 based on information output from the timing unit 28 is provided in the control unit 24.

The timing unit 28 serves to function as a timer having a timing function. Specifically, the timing unit 28 measures a time from a start of the reception of a radio signal using a selected receiving antenna 7, each time a different receiving antenna 7 is selected in the antenna selecting operation. The time measured by the timing unit 28 is used for the state determining unit 24c to determine a moving state of the capsule endoscope 2.

The moving-state calculating device 8 further includes a battery 29 that supplies driving power of each of the above constituent elements. The moving-state calculating device 8 includes the above constituent elements.

The operation of the moving-state detecting system according to the present embodiment is explained next. The moving-state detecting system according to the present embodiment has a function of performing an antenna selecting operation for selecting a receiving antenna 7 that receives a radio signal transmitted from the capsule endoscope 2, and a state determining operation for determining a moving state of the capsule endoscope 2 based on the antenna selection mode.

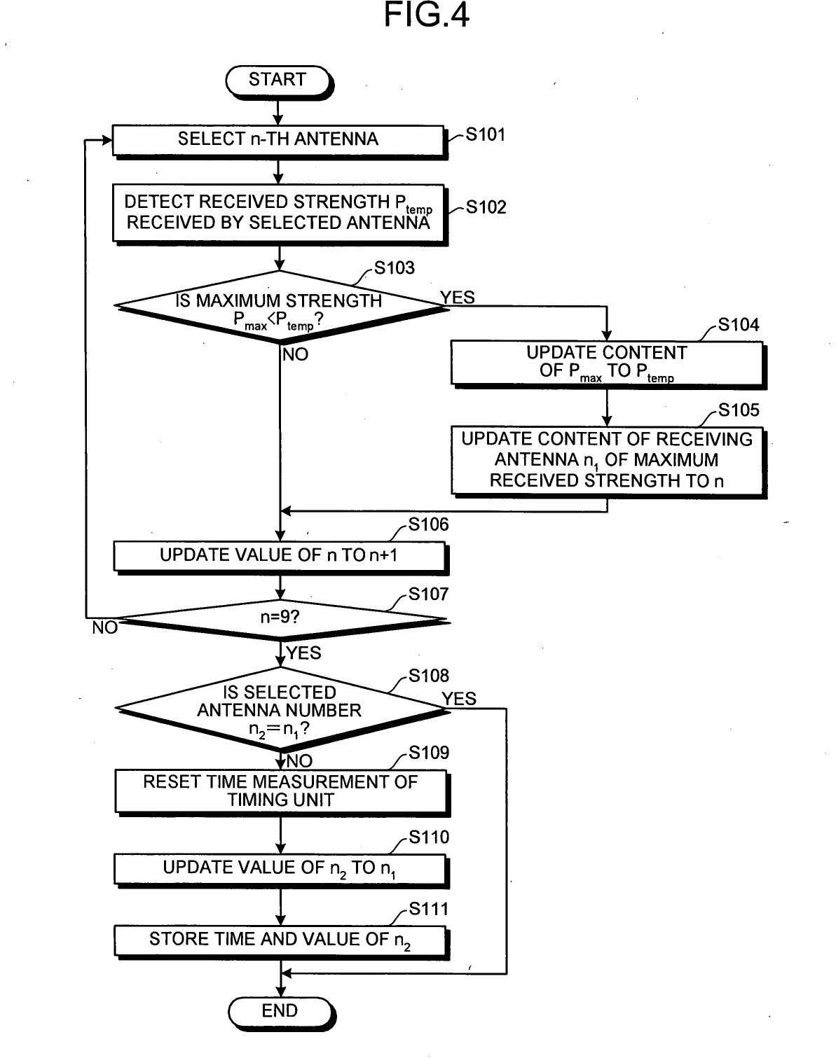

FIG. 4 is a flowchart for explaining the operation of the selection controller 24a in the antenna selecting operation. In the flowchart shown in FIG. 4, each of the receiving antennas 7a to 7h is referred to with a number n. For example, for the receiving antenna 7a, n=1, for the receiving antenna 7b, n=2, . . . , and for the receiving antenna 7h, n=8. Of the strength of radio signals received by the receiving antenna 7a to 7h, highest received strength is expressed as a maximum strength Pₘₐₓ, and a receiving antenna 7 that achieves this maximum strength is numbered as n₁. For example, when the received strength received by the receiving antenna 7a achieves the maximum strength Pₘₐₓ, n₁=1. A received strength that is actually detected is expressed as Pₜₑₘₚ, and a receiving antenna 7 that is selected as an antenna that receives a radio signal from the capsule endoscope 2 after the antenna selecting operation is numbered as n₂. When the antenna selecting operation is to be performed, n=1 and Pₘₐₓ=0 are set as initial values.

First, the selection controller 24a selects an n-th receiving antenna 7 (step S101), and detects the received strength Pₜₑₘₚ received by the selected receiving antenna 7 (step S102). The selection controller 24a determines a size relationship between the maximum strength Pₘₐₓ and the detected received strength Pₜₑₘₚ (step S103). When the received strength Pₜₑₘₚ is higher (step S102, Yes), the selection controller 24a updates the content of the maximum strength Pₘₐₓ to the received strength Pₜₑₘₚ (step S104), and updates the content of the number n₁ of the receiving antenna 7 that achieves the maximum received strength to n selected at step S101 (step S105).

On the other hand, when the value of the received strength Pₜₑₘₚ does not exceed the maximum strength Pₘₐₓ (step S103, No) or when step S105 ends, the selection controller 24a updates the content of the number n of the selected receiving antenna 7 to n+1, and determines whether the updated value of n is equal to 9 (step S107). When the updated value of n is smaller than 9 (step S107, No), the selection controller 24a repeats the operation at steps S101 to S106 again, using the updated value n. Based on this operation, received strength of the receiving antenna 7 of n=1 to 8, that is, the received strength of all the receiving antennas 7a to 7h, can be detected, and the number n₁ of a receiving antenna 7 that achieves the maximum received strength can be specified from the receiving antennas 7a to 7h.

When the operation at steps S101 to S106 is completed for n=9, that is, for the receiving antennas 7a to 7h (step S107, Yes), the selection controller 24a determines whether the number n₁ of the receiving antenna 7 that achieves the maximum received strength coincides with the number n₂ of the receiving antenna 7 that is selected to receive intra-subject information (step S108). When the number n₁ of the receiving antenna 7 does not coincide with the number n₂ of the receiving antenna 7 (step S108, No), the selection controller 24a resets the time measured by the timing unit 28 (step S109), and updates the value of the number n₂ of the selected receiving antenna 7 to the value of n₁ calculated in the process at steps S101 to S106. The selection controller 24a further outputs the updated n₂ to the antenna selector 21 (step S110). Lastly, the selection controller 24a stores the time detected by the time detector 27 and the value of n₂ (step S111).

When step S111 is completed or when it is determined that n₁=n₂ (step S108, Yes), the antenna selecting operation ends. The antenna selector 21 selects an antenna corresponding to n₂ for the receiving antenna 7 that is used for the radio signal, and outputs a radio signal received by the selected receiving antenna 7 to the receiving circuit 22. The process at steps S101 to S111 is performed plural times at predetermined time intervals, and a receiving antenna 7 which receives the highest received strength is suitably selected corresponding to the change of the position of the capsule endoscope 2 within the subject 1.

The selected receiving antenna 7 receives a radio signal transmitted from the capsule endoscope 2. In other words, the radio transmitting unit 10 radio transmits the intra-subject information, i.e., the intra-subject image information in the first embodiment, obtained by the intra-subject information acquiring unit 9 in the capsule endoscope 2. The moving-state detecting apparatus 3 receives the radio signal transmitted via the selected receiving antenna 7, and reproduces the intra-subject image through the receiving circuit 22 and the information extracting circuit 23. The reproduced intra-subject image is recorded into the portable recording medium 5 via the output interface 25.

Assume that the capsule endoscope 2 has moved to a position where the received strength received by the receiving antenna 7h is the highest, for example. In this case, at step S103 after the value of n is updated to 8, it is determined that the value of the received strength Pₜₑₘₚ of the radio signal received by the receiving antenna 7h is larger than the maximum received strength Pₘₐₓ (step S103, Yes), and the value of the received strength of the radio signal received by the receiving antenna 7h is registered as new maximum received strength Pₘₐₓ (step S104). At the same time, the value of the number n₁ of the receiving antenna 7 of the maximum received strength is updated to the value corresponding to the receiving antenna 7h, and n₁ is updated to n₁=8 (step S105). Through the above process, the selection controller 24a understands that the received strength of the radio signal received by the receiving antenna 7h is highest.

In the process at step S108 and afterward, the selected antenna is switched as necessary. In other words, at step S108, when the selected antenna number n₂ calculated in the past coincides with n₁, that is, when n₂=8 (step S108, Yes), the antenna selecting operation ends without any change process. On the other hand, when the receiving antenna selected in the past is different from the receiving antenna 7h, the selection controller 24a switches the value of the selected antenna number n₂ to 8 (step S109). At the same time, the selection controller 24a records the time when the selection switch is performed and the fact that the selected antenna has been switched to the receiving antenna 7h, to record the selection mode of the receiving antenna 7 (step S110). This information can be also recorded into the portable recording medium 5. Alternatively, a storage unit can be provided in the control unit 24, and the information can be temporarily stored in the storage unit, and thereafter, the information can be collectively recorded into the portable recording medium 5 after the capsule endoscope 2 is discharged to the outside of the subject 1. When the selected antenna is switched, the timing unit 28 is reset at step S109, and the timing unit 28 measures the elapsed time since the time when the selected antenna is switched.

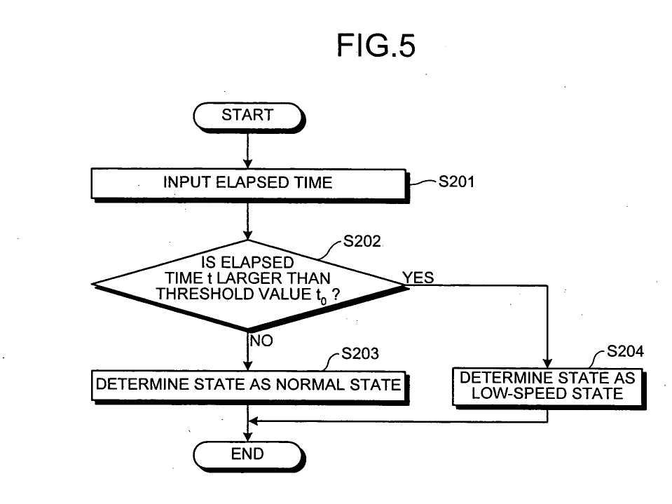

A determining operation of a moving state performed by the state determining unit 24c is explained next. FIG. 5 is a flowchart for explaining the determining operation performed by the state determining unit 24c. First, the state determining unit 24c inputs an elapsed time measured by the timing unit 28 (step S201), and determines whether an elapsed time t exceeds a predetermined threshold value to (step S202). When the elapsed time t exceeds the predetermined threshold value to (step S202, Yes), the state determining unit 24c determines that the capsule endoscope is in a low-speed moving state (step S203), and when the elapsed time t is smaller than the predetermined threshold value to (step S202, No), the state determining unit 24c determines that the capsule endoscope is in a normal moving state (step S204). The state determining unit 24c stores a result of the determination, and ends the process.

A moving-state determination mechanism of the state determining unit 24c is explained next. In the first embodiment, a radio signal used as a sensor signal has a characteristic that strength decreases gradually according to a transfer distance. A distance between a receiving antenna 7 and the capsule endoscope 2 can be estimated by detecting received strength received by the receiving antenna 7. In the first embodiment, a receiving antenna 7 having highest received strength of a radio signal is selected, as explained with reference to the flowchart shown in FIG. 4. A fact that the antenna selecting operation shown in the flowchart in FIG. 4 is performed means that a receiving antenna 7 nearest to the capsule endoscope 2 is selected.

Therefore, when a selected receiving antenna does not change even if the antenna selecting operation is performed plural times, it can be estimated that the capsule endoscope 2 is moving at a low speed within the subject 1. When a selected antenna changes frequently, it can be estimated that the capsule endoscope 2 is moving at a high speed within the subject 1. In the first embodiment, the state determining unit 24c performs determination based on this principle, thereby understanding a moving state of the capsule endoscope 2 within the subject 1.

Next, advantages of the moving-state detecting system according to the first embodiment are explained. First, the moving-state detecting system according to the first embodiment can detect a moving state of the capsule endoscope 2 within the subject 1. Therefore, in observing many intra-subject images that are picked up by the capsule endoscope 2, only a part of the intra-subject images can be observed, instead of observing all the intra-subject images corresponding to an area in which the capsule endoscope 2 is moving at a low speed. Accordingly, there is an advantage that effective diagnosis can be performed. Further, an imaging interval of the CCD 13 provided in the capsule endoscope 2 can be adjusted based on the detected moving state.

Further, the moving-state detecting system according to the first embodiment employs a configuration that detects a change in a moving state of the capsule endoscope 2 based on a change of a receiving antenna 7 selected by the antenna selector 21, as described above. It is common that a system including the plural receiving antennas 7a to 7h employs a mechanism that receives a radio signal using a receiving antenna 7 having the most satisfactory reception sensitivity. Based on the employment of a configuration that detects a moving state by using this mechanism, the moving-state detecting system according to the first embodiment can detect a moving state of the capsule endoscope 2 in a simple configuration. In other words, in the moving-state detecting system according to the first embodiment, constituent elements that are additionally necessary to detect a moving state are only the timing unit 28 and the state determining unit 24c. These constituent elements can be the ones that are simple and require low power consumption. Therefore, special constituent elements are not additionally required to allow for a detection of a moving state, and there occurs no additional problem such as an increase in power consumption.

### Second Embodiment

A moving-state detecting system according to a second embodiment is explained next. The moving-state detecting system according to the second embodiment includes a single receiving antenna, as a simple configuration, and detects a moving state of the capsule endoscope based on a change in the received strength of a radio signal received by the single receiving antenna. In the second embodiment, constituent elements that are common to the constituent elements in the first embodiment have configurations and functions similar to those of the first embodiment, unless otherwise particularly mentioned. Although not shown in the drawings, the moving-state detecting system according to the second embodiment also includes the capsule endoscope 2, the display device 4, and the portable recording medium 5 similarly to the first embodiment.

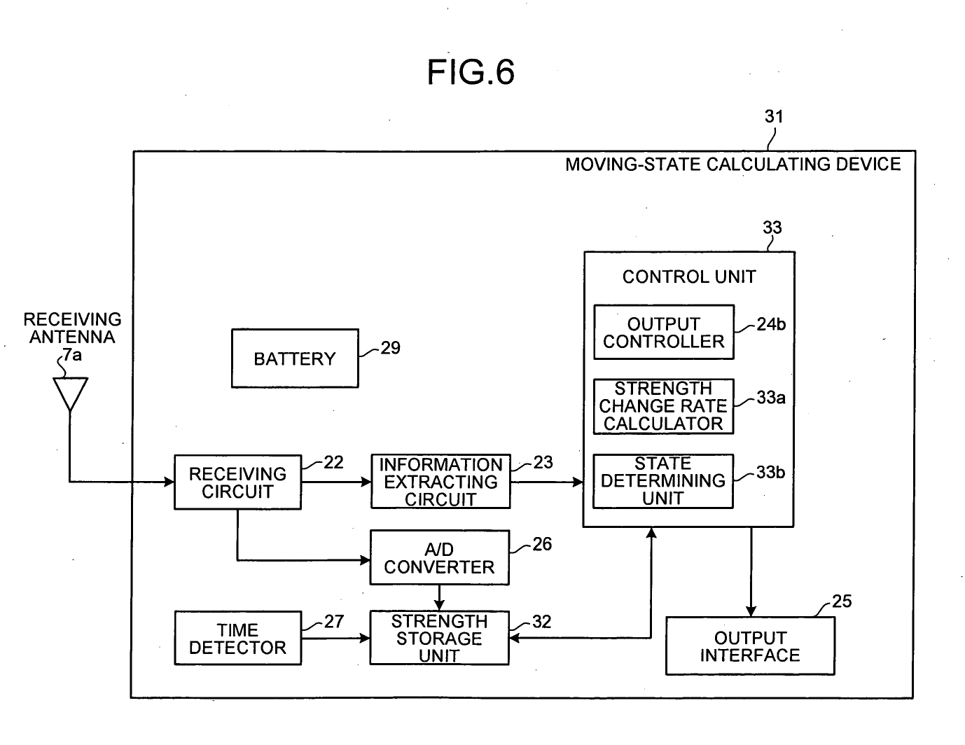

FIG. 6 is a block diagram showing a configuration of the moving-state detecting apparatus provided in the moving-state detecting system according to the second embodiment. As shown in FIG. 6, the moving-state detecting apparatus according to the second embodiment includes a single receiving antenna 7 having a configuration similar to that of the first embodiment, and a moving-state calculating device 31.

The moving-state calculating device 31 includes the receiving circuit 22, the information extracting circuit 23, the output interface 25, the A/D converter 26, and the time detector 27, like the first embodiment, and also includes a strength storage unit 32 that stores a received strength value output from the A/D converter 26 in association with a time output from the time detector 27, and a control unit 33.

The strength storage unit 32 stores strength of a radio signal received via the receiving antenna 7 in association with a reception time. Specifically, the strength storage unit 32 has a configuration into which information is input from the A/D converter 26 and the time detector 27, and has a function of outputting stored information to the control unit 33 following an instruction of the control unit 33.

The control unit 33 performs control corresponding to a moving-state determination mechanism of the second embodiment, in addition to the normal control operation. The control unit 33 includes the output controller 24b as in the first embodiment, and also additionally includes a strength change rate calculator 33a, and a state determining unit 33b.

The strength change rate calculator 33a calculates a change rate of received strength of a radio signal transmitted from the capsule endoscope 2 based on the information stored in the strength storage unit 32. The strength storage unit 32 stores received strength, and a time when the received strength is detected, as described above. The strength change rate calculator 33a calculates a difference between received strength at plural times, and calculates a change rate of received strength by dividing the difference of the received strength by a time difference, for example. The “change rate” in the second embodiment indicates not only a mathematical differential value but also a general value corresponding to a change of received strength according to a time change.

The state determining unit 33b determines a moving state of the capsule endoscope 2 based on a change rate of received strength calculated by the strength change rate calculator 33a. A moving-state determining operation performed by the state determining unit 33b is explained below.

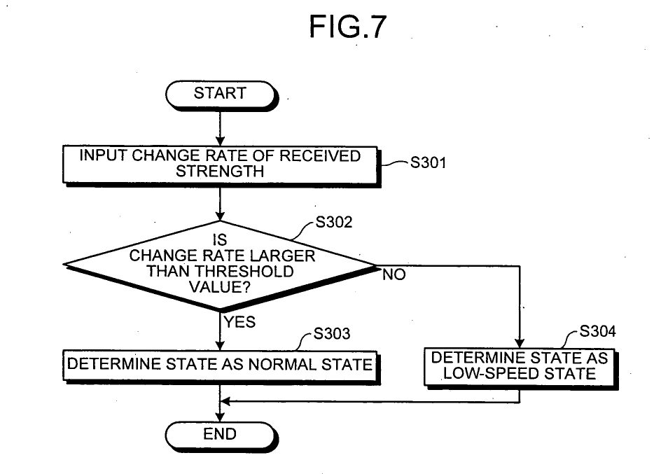

FIG. 7 is a flowchart for explaining the determining operation performed by the state determining unit 33b. As shown in FIG. 7, the state determining unit 33b inputs a change rate of received strength (step S301), and determines a size relationship between the input change rate and a predetermined threshold value (step S302). When the change rate of received strength exceeds the threshold value (step S302, Yes), the state determining unit 33b determines that the moving state of the capsule endoscope 2 is in the normal state (step S303), and when the change rate of received strength does not exceed the threshold value (step S302, No), the state determining unit 33b determines that the moving state of the capsule endoscope 2 is in the slow-speed state (step S304). The state determining unit 33b stores a result of the determination as above, and completes the determining operation.

The principle of the determining operation performed by the state determining unit 33b is briefly explained. As explained above, a radio signal transmitted from the capsule endoscope 2 has a characteristic that the strength of the radio signal is attenuated according to a transfer distance. Therefore, a value of received strength of a radio signal received via the receiving antenna 7 reflects a distance between the receiving antenna 7 and the capsule endoscope 2. In view of the fact that the receiving antenna 7 is fixed to substantially a fixed position on the body surface of the subject 1, a change rate of received strength takes a value corresponding to a rate of a position change of the capsule endoscope 2.

The moving-state detecting system according to the second embodiment detects a moving state based on a change rate of received strength, by using the above principle. In other words, when a change rate of received strength is large, it is estimated that the capsule endoscope 2 is moving at a high speed relative to the receiving antenna 7, and when a change rate of received strength is small, it is estimated that the capsule endoscope 2 is moving at a low speed relative to the receiving antenna 7. Based on this estimate, in the second embodiment, when a change rate is equal to or higher than a predetermined threshold value, it is estimated that the capsule endoscope 2 is moving in the normal state, and when a change rate is lower than the predetermined threshold value, it is estimated that the capsule endoscope 2 is moving in the low-speed state.

### Third Embodiment

A moving-state detecting system according to a third embodiment is explained next. The moving-state detecting system according to the third embodiment includes plural receiving antennas, and detects a moving state of the capsule endoscope 2 by making a comprehensive determination of change rates of received strength received by the plural receiving antennas. In the third embodiment, constituent elements that are common to the constituent elements in the first embodiment have configurations and functions similar to those of the first embodiment, unless otherwise particularly mentioned. Although not shown in the drawings, the moving-state detecting system according to the third embodiment also includes the capsule endoscope 2, the display device 4, and the portable recording medium 5 similarly to the first embodiment.

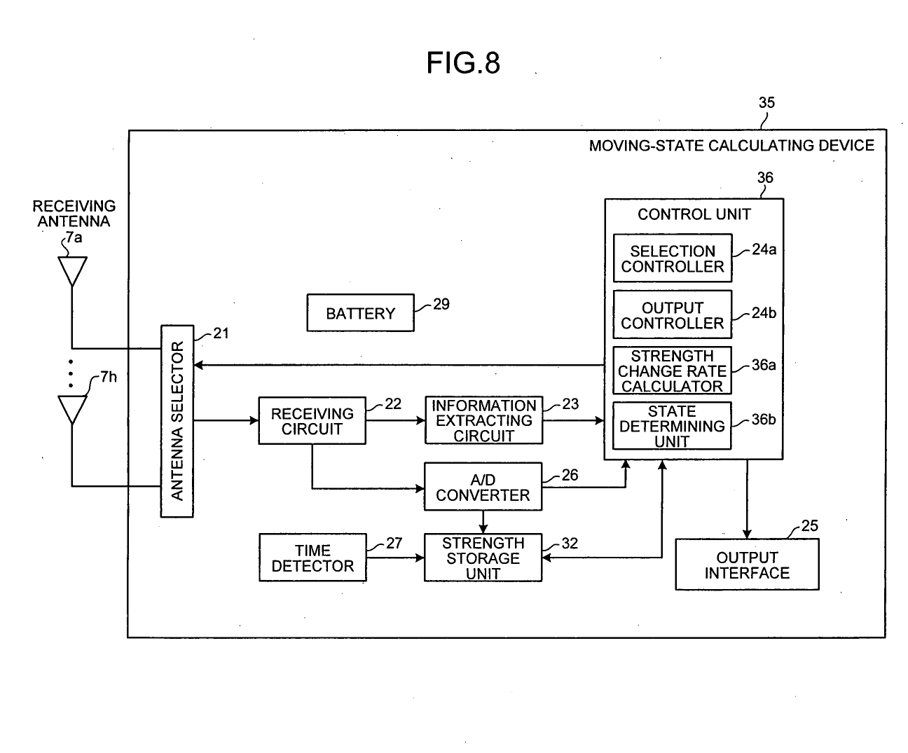

FIG. 8 is a schematic diagram showing a configuration of the moving-state detecting apparatus provided in the moving-state detecting system according to the third embodiment. As shown in FIG. 8, the moving-state detecting apparatus according to the third embodiment includes the receiving antennas 7a to 7h. A moving-state calculating device 35 includes the antenna selector 21, the receiving circuit 22, the information extracting circuit 23, the output interface 25, the time detector 27, and the battery 29, as in the first embodiment, and also includes the strength storage unit 32 similar to that in the second embodiment. The moving-state calculating device 35 additionally includes a control unit 36. The control unit 36 includes the selection controller 24a and the output controller 24b as in the first embodiment, and also includes a strength change rate calculator 36a that calculates a change rate of received strength received by each of the receiving antennas 7a to 7h, and a state determining unit 36b that determines a moving state of the capsule endoscope 2 based on a change rate of the calculated received strength.

The strength change rate calculator 36a calculates a change rate of strength of a radio signal received by each of the receiving antennas 7a to 7h. The calculation process to calculate change rates concerning the receiving antennas 7a to 7h is similar to the process performed by the strength change rate calculator 33a in the second embodiment. Specifically, the strength change rate calculator 36a calculates change rates of received strength received by the receiving antennas 7a to 7h, based on the received strength received by the receiving antennas 7a to 7h stored in the strength storage unit 32, and times when the received strength is detected.

The state determining unit 36b determines a moving state of the capsule endoscope 2. Specifically, the state determining unit 36b has a function of determining a moving state of the capsule endoscope 2, based on the change rates of received strength concerning the receiving antennas 7a to 7h calculated by the strength change rate calculator 36a.

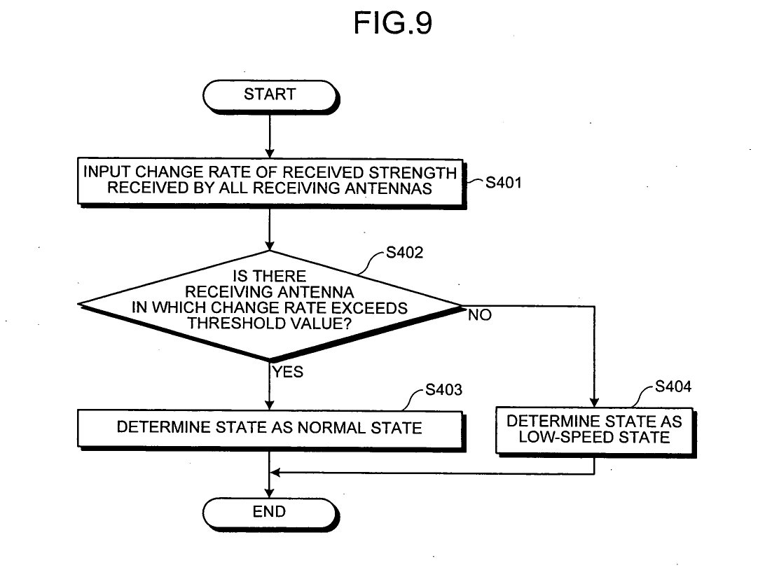

A moving-state determining operation of the capsule endoscope 2 in the moving-state detecting system according to the third embodiment is explained next. FIG. 9 is a flowchart for explaining the determining operation performed by the state determining unit 36b to determine the moving state.

First, the state determining unit 36b inputs a change rate of received strength received by each of the receiving antennas 7a to 7h calculated by the strength change rate calculator 36a (step S401). The state determining unit 36b determines whether there is a change rate that exceeds a predetermined threshold value in the input change rates of received strength (step S402). When there is a change rate that exceeds the predetermined threshold value in the input change rates of received strength (step S402, Yes), the state determining unit 36b determines that the moving state is a normal state (step S403). When none of the change rates of the received strength exceed the threshold value (step S402, No), the state determining unit 36b determines that the moving state is a low-speed state (step S404), and the process ends there.

Advantages of the moving-state detecting system according to the third embodiment are explained below. First, the moving-state detecting system according to the third embodiment has an advantage that this system can detect a moving state of the capsule endoscope 2 in a simple configuration, similarly to the first embodiment.

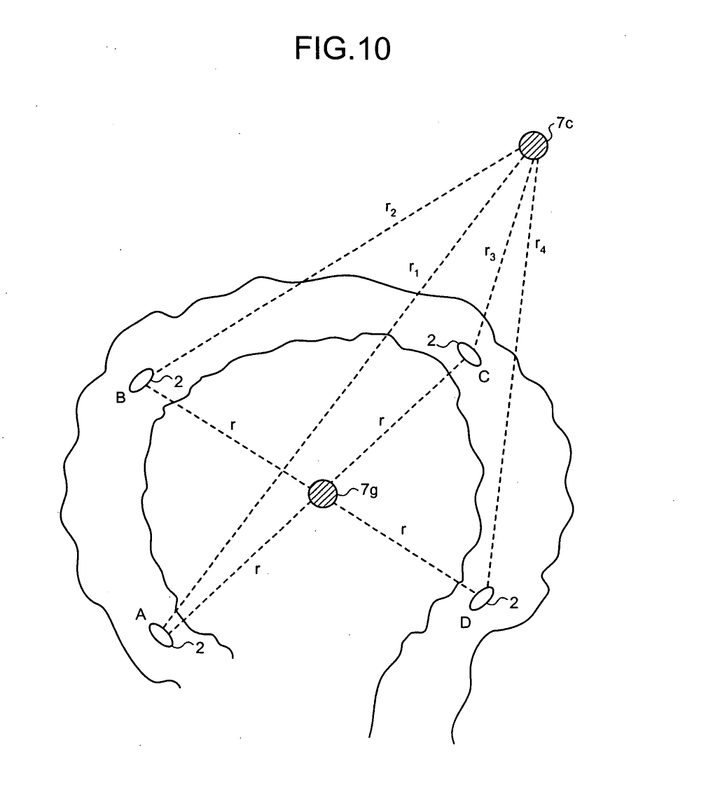

Further, the moving-state detecting system according to the third embodiment has an advantage that the system can detect a moving state more accurately. FIG. 10 is a schematic diagram for explaining the advantage of the moving-state detecting system according to the third embodiment. FIG. 10 shows a state the capsule endoscope 2 is moving within a large intestine, as an example. The capsule endoscope 2 sequentially passes through a point A, a point B, a point C, and a point D shown in FIG. 10. It is assumed that the receiving antennas 7c and 7g are disposed at positions shown in FIG. 10 (other receiving antennas are not shown).

As shown in FIG. 10, distances from the receiving antenna 7g to the points A, B, C, and D, respectively are substantially equal to r. In this case, when the capsule endoscope 2 is positioned at each of the points A, B, C, and D, the received strength of a radio signal received by the receiving antenna 7g is substantially the same. Therefore, when a change rate of received strength concerning only the receiving antenna 7g is calculated, the change rate becomes substantially zero, even when the capsule endoscope 2 moves in the normal state. As a result, there is a risk that the state determining unit 36b determines that the capsule endoscope 2 is moving in a low-speed state.

On the other hand, distances from the receiving antenna 7c to the points A, B, C, and D, respectively are r₁ to r₄, which are different from each other. Therefore, when the capsule endoscope 2 reaches each of the points A, B, C, and D, the receiving antenna 7c receives radio signals at different received strength corresponding to the respective points. Accordingly, when the state determining unit 36b determines a moving state of the capsule endoscope 2 by using change rates of received strength received by the plural receiving antennas 7a to 7h, respectively as in the third embodiment, there is the advantage that the moving state can be detected correctly, even when the capsule endoscope 2 moves in a manner as shown in FIG. 10.

### Fourth Embodiment

A moving-state detecting system according to a fourth embodiment is explained next. The moving-state detecting system according to the fourth embodiment has a configuration that understands a moving state of the capsule endoscope 2 within the subject 1 by detecting a change rate of a position of the capsule endoscope 2. In the fourth embodiment, constituent elements that are common to the constituent elements in the first embodiment have configurations and functions similar to those of the first embodiment, unless otherwise particularly mentioned. Although not shown in the drawings, the moving-state detecting system according to the fourth embodiment also includes the capsule endoscope 2, the display device 4, and the portable recording medium 5 similarly to the first embodiment.

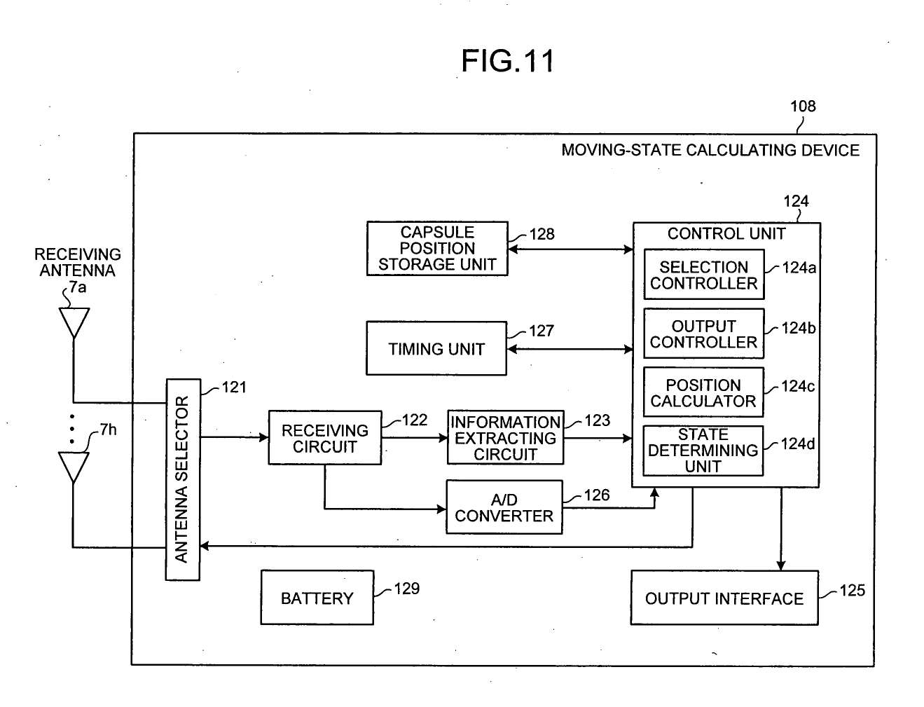

FIG. 11 is a schematic diagram showing a configuration of a moving-state detecting apparatus provided in a moving-state detecting system according to the fourth embodiment. As shown in FIG. 11, the moving-state detecting apparatus according to the fourth embodiment includes the receiving antennas 7a to 7h. A moving-state calculating device 108 includes an antenna selector 121, a receiving circuit 122, an information extracting circuit 123, a control unit 124, an output interface 125, an A/D converter 126, a timing unit 127, and a battery 129, instead of the antenna selector 21, the receiving circuit 22, the information extracting circuit 23, the control unit 24, the output interface 25, the A/D converter 26, the timing unit 28, and the battery 29, respectively in the first embodiment. The moving-state calculating device 108 also additionally includes a capsule position storage unit 128, eliminating the time detector 27 according to the first embodiment.

The moving-state calculating device 108 includes a mechanism that selects plural receiving antennas 7 which are suitable for reception from the receiving antennas 7a to 7h, and a mechanism that acquires intra-subject information, i.e., information concerning an intra-subject image according to the fourth embodiment, from radio signals received via the selected receiving antennas 7. Further, the moving-state calculating device 108 includes a mechanism that calculates a position of the capsule endoscope 2 based on received strength of radio signals received by the selected receiving antennas 7, and a mechanism that understands a moving state of the capsule endoscope 2 based on a manner of change of a calculated position of the capsule endoscope 2.

First, as a mechanism that selects receiving antennas 7 which are suitable for reception from the receiving antennas 7a to 7h, the moving-state calculating device 108 includes the antenna selector 121 that outputs only radio signals received via the selected receiving antennas 7, out of the radio signals received by the receiving antennas 7a to 7h, respectively, the receiving circuit 122 that performs a predetermined process to the radio signals input via the antenna selector 121, and the A/D converter 126 that analog-to-digital converts the received strength signals output from the receiving circuit 122. A selection controller 124a that performs a predetermined control in the antenna selecting operation is provided within the control unit 124.

The antenna selector 121 selects a receiving antenna 7 which is suitable to receive a radio signal transmitted from the capsule endoscope 2 from the receiving antennas 7a to 7h. As shown in FIG. 1, the receiving antennas 7a to 7h are disposed at different positions on the body surface of the subject 1. When the capsule endoscope 2 moves within the subject 1, a distance from each of the receiving antennas 7a to 7h to the capsule endoscope 2 changes. Therefore, in the fourth embodiment, the plural receiving antennas 7a to 7h are provided, and the antenna selector 121 selects a receiving antenna 7 which is most suitable to receive the radio signal transmitted from the capsule endoscope 2. Specifically, the antenna selector 121 has a function of selecting a receiving antenna 7, based on the control of the selection controller 124a provided in the control unit 124.

The receiving circuit 122 performs a predetermined process to the radio signal received via any one of the receiving antennas 7a to 7h. Specifically, the receiving circuit 122 has a function of performing a process necessary to extract intra- subject information described later, and outputting a signal corresponding to the received strength of the radio signal, such as RSSI (Received Signal Strength Indicator), in a format of an analog signal, to the A/D converter 126.

The selection controller 124a is provided within the control unit 124, and is used to select an antenna based on received strength in each of the receiving antennas 7a to 7h. Specifically, the selection controller 124a selects three receiving antennas 7 suitable for reception based on received strength value input via the A/D converter 126, and controls the antenna selector 121 to output only the radio signals received via the selected receiving antennas 7, to the receiving circuit 122. A specific antenna selection algorithm of the selection controller 124a is explained in detail later.

As the mechanism that acquires intra-subject information, the moving-state calculating device 108 includes the information extracting circuit 123 that extracts intra-subject information, i.e., intra-subject image information in the fourth embodiment, from radio signals subjected to a predetermined process via the antenna selector 121 and the receiving circuit 122, and the output interface 125 that outputs the extracted intra-subject image and the like to the portable recording medium 5. An output controller 124b that controls the output operation of the obtained intra-subject information is provided within the control unit 124.

The output interface 125 outputs information output from the control unit 124, to the portable recording medium 5. Specifically, the output interface 125 has a physical configuration to which the portable recording medium 5 can be mounted, and has a function of writing information output from the control unit 124 to the portable recording medium 5, based on the control of the output controller 124b.

Further, the moving-state calculating device 108 has a configuration including a position calculator 124c within the control unit 124, as a mechanism that calculates a position of the capsule endoscope 2 within the subject 1. The position calculator 124c has a function of calculating a position of the capsule endoscope 2, based on the received strength received by the plural receiving antennas 7 selected by the antenna selector 121, and the positions of the selected plural receiving antennas 7.

Further, the moving-state calculating device 108 has the timing unit 127 and the capsule position storage unit 128, as a mechanism that calculates a moving state of the capsule endoscope 2, and has a configuration including a state determining unit 124d within the control unit 124.

The timing unit 127 outputs a time to the control unit 124. In the fourth embodiment, the timing unit 127 outputs a time at which the position calculator 124c calculates a position of the capsule endoscope 2, to the control unit 124, based on an instruction of the control unit 124.

The capsule position storage unit 128 stores a position of the capsule endoscope 2 calculated by the position calculator 124c in association with the time of calculation that is output from the timing unit 127. The capsule position storage unit 128 has a function of storing positions of the capsule endoscope 2 at plural times corresponding to the calculation of positions performed plural times by the position calculator 124c in association with the times of calculation, and outputting the stored information based on an instruction of the state determining unit 124d.

The state determining unit 124d determines a moving state of the capsule endoscope 2, based on the positions of the capsule endoscope 2 at plural times, and the times of calculation of these positions. Specifically, the state determining unit 124d has a function of calculating a change rate of a position of the capsule endoscope 2 based on the positions of the capsule endoscope 2 at plural times, and determining a moving state of the capsule endoscope 2 based on the calculated change rate. Details of the determining function are explained later.

The moving-state calculating device 108 further includes the battery 129 that supplies driving power of each of the above constituent elements. The moving-state calculating device 108 includes the constituent elements mentioned above.

The operation of the moving-state detecting system according to the fourth embodiment is explained next. The moving-state detecting system according to the fourth embodiment has a function of performing a position deriving antenna selecting operation of selecting plural receiving antennas 7 that are used to calculate a position of the capsule endoscope 2 inserted into the subject 1 from the receiving antennas 7a to 7h, a position calculating operation of calculating a position of the capsule endoscope 2 based on received strength of radio signals received by the selected receiving antennas 7, and a moving-state calculating operation of calculating a moving state of the capsule endoscope 2, based on the calculated position. These operations are sequentially explained below.

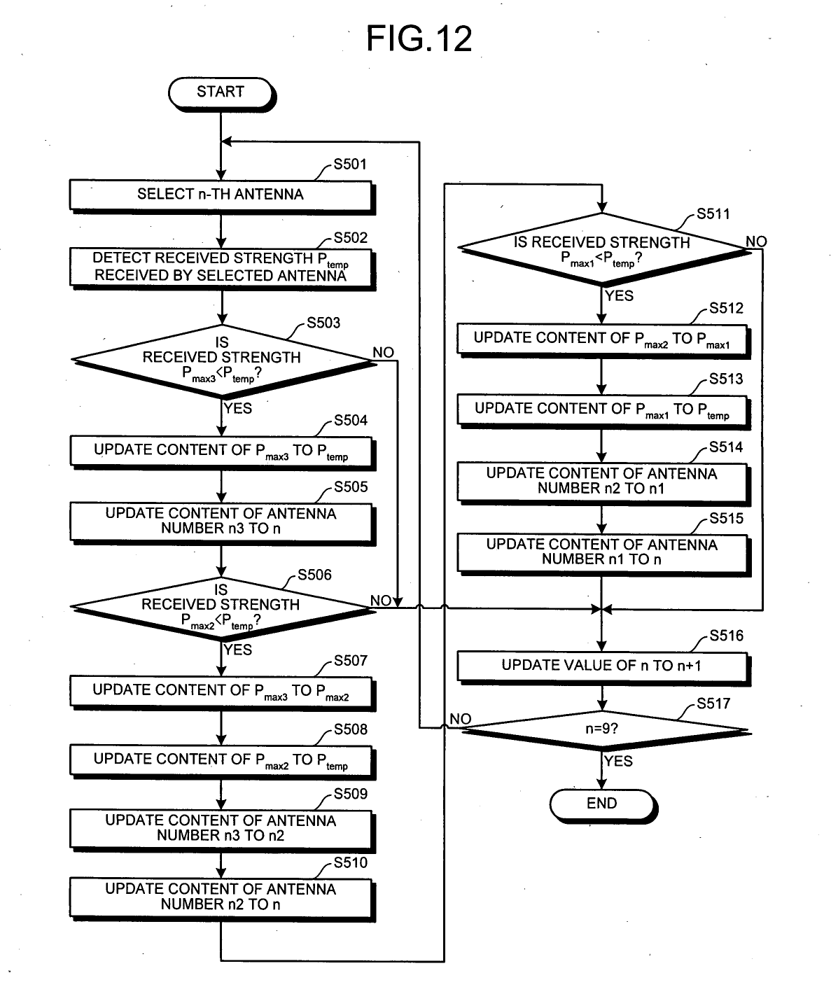

First, the position deriving antenna selecting operation of selecting a receiving antenna 7 to be used to calculate a position is explained. FIG. 12 is a flowchart showing a process performed by the selection controller 124a in the operation of selecting a position deriving antenna. The position deriving antenna selecting operation is explained below with reference to FIG. 12 where appropriate.

In the flowchart shown in FIG. 12, each of the receiving antennas 7a to 7h is referenced with a number n. For example, for the receiving antenna 7a, n=1, for the receiving antenna 7b, n=2, . . . , and for the receiving antenna 7h, n=8. Among the strength of radio signals received by the receiving antennas 7a to 7h, a highest received strength is expressed as strength Pₘₐₓ₁, a second highest strength is expressed as received strength Pₘₐₓ₂, and a third highest strength is expressed as received strength Pₘₐₓ₃. Receiving antennas 7 that have the received strength Pₘₐₓ₁, Pₘₐₓ₂, and Pₘₐₓ₃ are numbered as n1, n2, n3, respectively. For example, when the received strength received by the receiving antenna 7a achieves the received strength Pₘₐₓ₁, n1=1. A received strength that is detected by the receiving antenna 7 selected in the flowchart in FIG. 12 is expressed as Pₜₑₘₚ. The selection controller 124a stores the values of the received strength Pₘₐₓ₁, Pₘₐₓ₂, and Pₘₐₓ₃ as 0, and stores the value of the antenna number n as 1, as initial setting values before starting the process shown in the flowchart in FIG. 12.

First, the selection controller 124a selects an n-th receiving antenna 7 (step S501), and detects the received strength Pₜₑₘₚ received by the selected receiving antenna 7 (step S502). The selection controller 124a determines a size relationship between the set received strength Pₘₐₓ₃ and the detected received strength Pₜₑₘₚ (step S503). When the received strength Pₜₑₘₚ exceeds the received strength Pₘₐₓ₃ (step S503, Yes), the selection controller 124a updates the received strength Pₘₐₓ₃ and the antenna number n3. In other words, the value of the received strength Pₘₐₓ₃ is updated to the value of the received strength Pₜₑₘₚ detected at step S502 (step S504), and the value of the antenna number n3 is updated to the value of n as the number of the receiving antenna 7 selected at step S501 (step S505). When the received strength Pₜₑₘₚ is lower than the received strength Pₘₐₓ₃, the process proceeds to step S516 described later.

Thereafter, the selection controller 124a determines a size relationship between the received strength Pₜₑₘₚ detected at step S502 and the received strength Pₘₐₓ₂ set in advance (step S506). When the received strength Pₜₑₘₚ is higher (step S506, Yes), the values of the received strength Pₘₐₓ₂ and Pₘₐₓ₃, and the antenna numbers n2 and n3 are updated. In other words, the value of the received strength Pₘₐₓ₃ is updated to the value of the received strength Pₘₐₓ₂ (step S507), and the value of the received strength Pₘₐₓ₂ is updated to the value of the received strength Pₜₑₘₚ detected at step S502 (step S508). The value of the antenna number n3 is updated to the value of n2 (step S509), and the value of the antenna number n2 is updated to the value of n selected at step S501 (step S510). When the received strength Pₜₑₘₚ is lower than the received strength Pₘₐₓ₂ (step S506, No), the process proceeds to step S516 described later.

Thereafter, the selection controller 124a determines a size relationship between the received strength Pₜₑₘₚ detected at step S502 and the received strength Pₘₐₓ₁ set in advance (step S511). When the received strength Pₜₑₘₚ is higher (step S511, Yes), the received strength Pₘₐₓ₁ and Pₘₐₓ₂, and the antenna numbers n1 and n2 are updated. In other words, the value of the received strength Pₘₐₓ₂ is updated to the value of the received strength Pₘₐₓ₁ (step S512), and the value of the received strength Pₘₐₓ₁ is updated to the value of the received strength Pₜₑₘₚ (step S513). The value of the antenna number n2 is updated to the value of the antenna number n1 (step S514), and the value of the antenna number n1 is updated to the value of the antenna number n (step S515). The process proceeds to step S516. When the received strength Pₜₑₘₚ is lower than the received strength Pₘₐₓ₁ (step S511, No), the process proceeds to step S516 without performing the process at steps S512 to S515.

The selection controller 124a updates the antenna number n determined at step S501 to n+1 (step S516), and determines whether the updated antenna number n is equal to 9 (step S517). When the antenna number n is equal to 9 (step S517, Yes), this means that the process at steps S501 to S515 is completed for all the receiving antennas 7a to 7h, and all process ends. When the antenna number n is not equal to 9 (step S517, No), the process is repeated from step S501 again using the antenna number n updated at step S516.

By executing the above process, three receiving antennas to be used to perform the position calculating operation are selected from the receiving antennas 7a to 7h. In other words, in the process at steps S501 to S517, receiving antennas 7 corresponding to the antenna numbers n1, n2, n3 are selected, that is, a receiving antenna having a highest received strength, a receiving antenna having a second highest received strength, and a receiving antenna having a third highest received strength are selected, from the receiving antennas 7a to 7h. These three receiving antennas 7 are used to calculate a position of the capsule endoscope 2.

In the fourth embodiment, one receiving antenna 7 is selected from the selected three receiving antennas 7, and the selected one receiving antenna 7 is used to receive a radio signal transmitted from the capsule endoscope 2. In other words, in the fourth embodiment, the radio signal transmitted from the capsule endoscope 2 functions as a sensor signal. This radio signal is transmitted in the state of including intra-subject information (an intra-subject image in the fourth embodiment) acquired by the capsule endoscope 2. Therefore, the moving-state calculating device 108 has a function of extracting this intra-subject information. Specifically, the moving-state calculating device 108 selects a receiving antenna 7 that receives a signal of the received strength Pₘₐₓ₁, for example, and receives the radio signal via the selected receiving antenna 7. After the receiving circuit 122 and the information extracting circuit 123 execute a predetermined process, the moving-state calculating device 108 extracts the intra-subject information. The portable recording medium 5 stores the intra-subject information via a control unit 137 and the output interface 125.

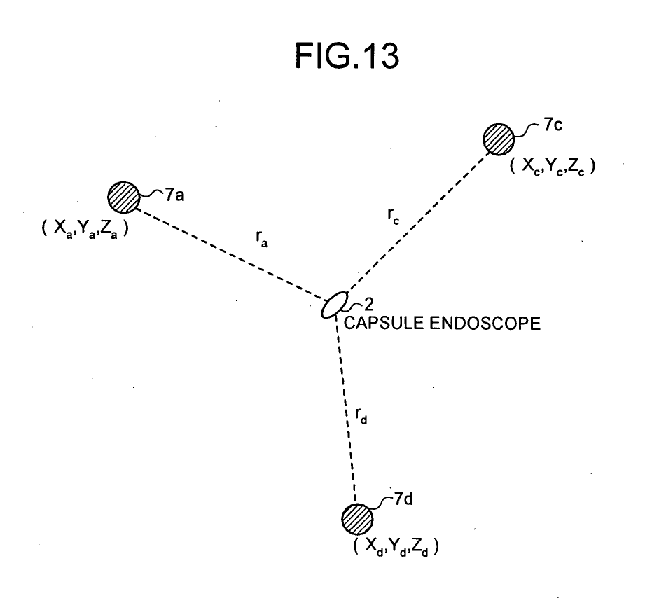

The position calculating operation of calculating the position of the capsule endoscope 2 using the three receiving antennas 7 selected in the position deriving antenna selecting operation is briefly explained next. FIG. 13 is a schematic diagram for explaining the position calculating operation performed by the position calculator 124c. FIG. 13 is an example where the selection controller 124a selects the receiving antennas 7a, 7c, 7d. It is needless to mention that FIG. 13 shows only one example, and the selected receiving antennas are different depending on the position and the like of the capsule endoscope 2 within the subject 1.

It is assumed that the position calculator 124c understands position coordinates of the receiving antennas 7a to 7h in advance, and understands position coordinates (xₐ,yₐ,zₐ), (x_{c},y_{c},z_{c}) and (x_{d},y_{d},z_{d}) of the receiving antennas 7a, 7c, 7d, respectively. Received strength received by the receiving antennas 7a, 7c, 7d are grasped in the above position deriving antenna selecting operation. The position calculator 124c calculates the position of the capsule endoscope 2 based on these pieces of information.

In other words, the received strength received by the receiving antennas 7a, 7c, 7d are the values corresponding to distances between these antennas and the capsule endoscope 2. Specifically, because a radio signal transmitted from the capsule endoscope 2 is attenuated in proportion to the (−3)-rd power of the distance, the position calculator 124c calculates distances rₐ, r_{c}, r_{d} between the capsule endoscope 2 and the receiving antennas 7a, 7c, 7d, respectively, based on this proportional relationship. The position calculator 124c calculates
(x_{z}−x)²+(yₐ−y)²+(zₐ−z)²=rₐ² (1)
(x_{c}−x)²+(y_{c}−y)²+(z_{c}−z)²=r_{c}² (2)
(x_{d}−x)²+(y_{d}−y)²+(z_{d}−z)²=r_{d}² (3)
for the position coordinates (x,y,z) of the capsule endoscope, using these distance values and the positions of the receiving antennas 7a, 7c, 7d, for example, thereby calculating the respective values of (x,y,z), and the position calculating operation of the capsule endoscope 2 is completed. The calculated positions of the capsule endoscope 2 are stored in the capsule position storage unit 128 in association with the time of calculation, and are also stored in the portable recording medium 5 via the output interface 125.

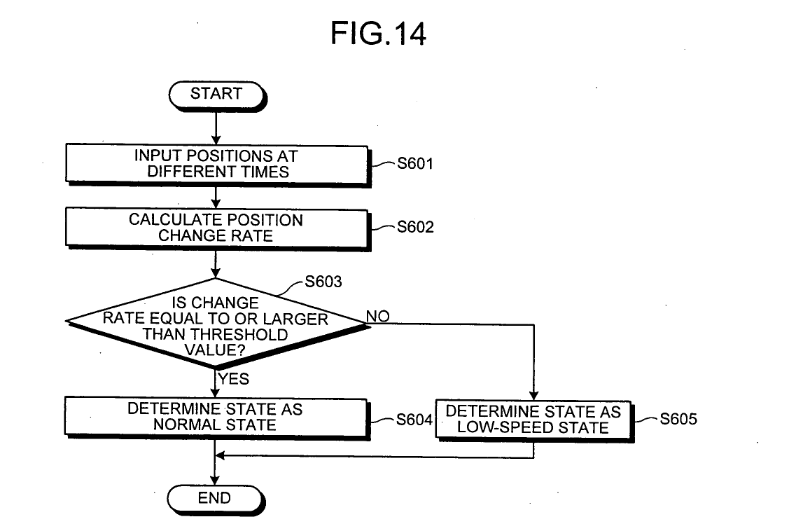

A moving-state determining operation performed using the state determining unit 124d provided in the control unit 124 is explained next. FIG. 14 is a flowchart showing the operation of the state determining unit 124d to determine a moving state. The moving-state determining operation is explained below with reference to FIG. 14.

First, the state determining unit 124d inputs information concerning positions of the capsule endoscope 2 at different plural times, based on the information stored in the capsule position storage unit 128 (step S601), and calculates a change rate of the position of the capsule endoscope 2, based on the input information (step S602). For example, the state determining unit 124d calculates a position change rate (Δr/Δt), using position coordinates (x₁,y₁,z₁) of the capsule endoscope 2 calculated at a time t1, and position coordinates (x₂,y₂,z₂) of the capsule endoscope 2 calculated at a time t2, as
Δr/Δt={(x₂−x₁)²+(y₂−y₁)²+(z₂−z₁)²)^{1/2}/(t2−t1) (4),
and calculates a position change rate of the capsule endoscope 2.

The state determining unit 124d determines whether the calculated change rate is equal to or larger than a predetermined threshold value (step S603). When it is determined that the calculated change rate is equal to or larger than the predetermined threshold value (step S603, Yes), the state determining unit 124d determines that a moving state of the capsule endoscope 2 is a normal state (step S604). When it is determined that the calculated change rate is smaller than the predetermined threshold value (step S603, No), the state determining unit 124d determines that a moving state of the capsule endoscope 2 is a low-speed state (step S605) Thereafter, the calculated determination result is recorded into the portable recording medium 5 via the output interface 125. The capsule endoscope 2 is discharged to the outside of the subject 1, and the intra-subject image and the moving state are displayed in the display device 4.

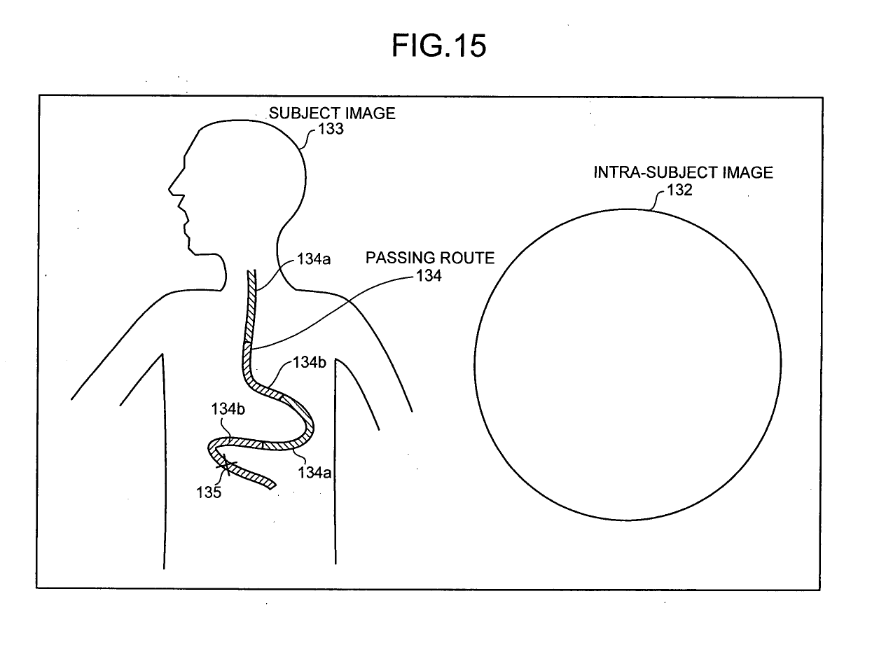

FIG. 15 is a schematic diagram showing one example of a display mode on the screen of the display device 4 based on the information recorded in the portable recording medium 5. As shown in FIG. 15, an intra-subject image 132 picked up by the CCD 13 provided in the capsule endoscope 2 is displayed, and a subject image 133 that schematically shows an external shape of the subject 1 is also displayed, on the screen of the display device 4. A passing route 134 of the capsule endoscope 2 within the subject 1 and an imaging position 135 of the intra-subject image 132 are displayed within the subject image 133. The displayed passing route 134 is formed with normal areas 134a through which the capsule endoscope 2 moves in the normal state, and low- speed areas 134b through which the capsule endoscope 2 moves in the low-speed state. The normal area 134a and the low-speed area 134b are calculated based on a result of determination performed by a state determining unit 137d. When the normal area 134a and the low-speed area 134b are displayed on the screen, a doctor, a nurse, or the like can understand at which part within the subject 1 the capsule endoscope 2 is in the low-speed state, in performing diagnosis using the intra-subject image.

Advantages of the moving-state detecting system according to the fourth embodiment are explained next. First, the moving-state detecting system according to the fourth embodiment can understand the moving state of the capsule endoscope 2 within the subject 1, by using a change rate of the position of the capsule endoscope 2. Therefore, in observing many intra-subject images picked up by the capsule endoscope 2, for example, there is an advantage that only a part of the images can be observed, without observing all the intra-subject images corresponding to the area in which the capsule endoscope 2 is determined to move in the low-speed state, whereby efficient diagnosis is allowed. Further, it is possible to achieve, for example, such a configuration that adjusts an interval of imaging performed by the CCD 13 provided in the capsule endoscope 2, based on the detected moving state.

As shown in FIG. 15, the moving-state detecting system according to the fourth embodiment displays not only the intra-subject image 132 but also the moving state of the capsule endoscope 2, on the screen of the display device 4. Based on the employment of this display mode, a doctor, a nurse, or the like can visually understand a change in the moving state, such as at which part within the subject 1 the capsule endoscope 2 is in the low-speed state.

### Fifth Embodiment

A moving-state detecting system according to a fifth embodiment is explained next. The moving-state detecting system according to the fifth embodiment has a configuration that detects a moving state of a capsule endoscope, based on a length of a time during which a predetermined receiving antenna is continuously selected.

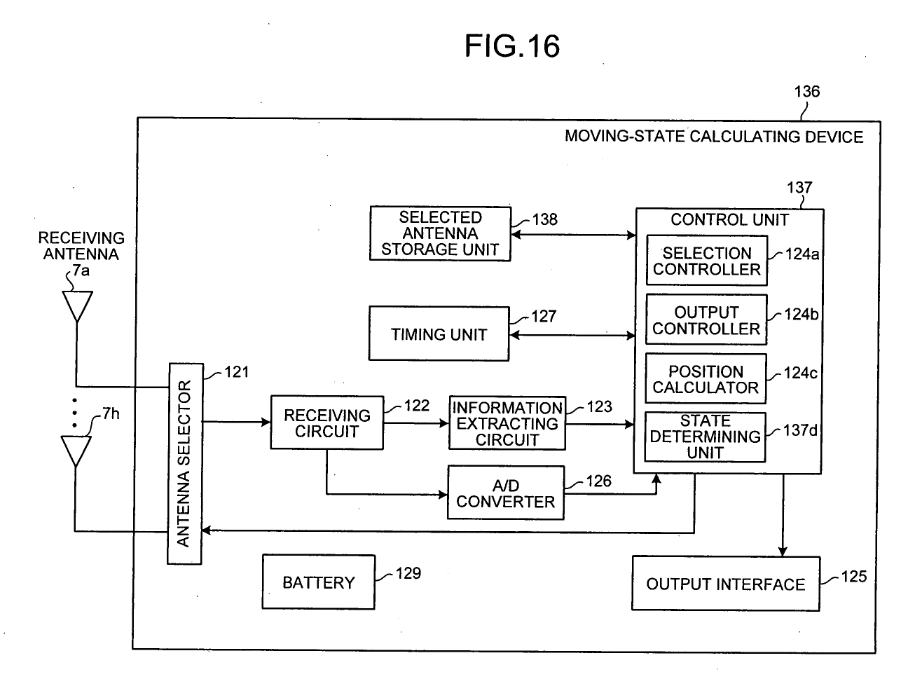

FIG. 16 is a block diagram showing a configuration of a moving-state calculating device 136 provided in the moving-state detecting system according to the fifth embodiment. In the fifth embodiment, constituent elements whose reference numerals and names are common to those of the constituent elements in the fourth embodiment have configurations and functions similar to those of the fourth embodiment, unless otherwise particularly mentioned. Although not shown in the drawings, a body-insertable system according to the fifth embodiment also includes the capsule endoscope 2, the display device 4, and the portable recording medium 5 similarly to the first embodiment.

As shown in FIG. 16, the moving-state detecting system includes the antenna selector 121, the receiving circuit 122, the information extracting circuit 123, the A/D converter 126, the output interface 125, the timing unit 127, and the battery 129 similarly to the fourth embodiment, and also includes a selected antenna storage unit 138 which stores information concerning a selected receiving antenna 7, and the control unit 137 including a state determining unit 137d that determines a moving state of the capsule endoscope 2 based on a length of time during which the same receiving antenna is continuously selected using the information stored in the selected antenna storage unit 138.

The selected antenna storage unit 138 has a function of storing history information of the selected antenna. The history information is information associating identification information of a receiving antenna 7 selected by the selection controller 124a with a time of the selection. Specifically, the selected antenna storage unit 138 stores the information that identifies a receiving antenna 7 selected by the selection controller 124a, and the information concerning a time when the selection controller 124a selects the antenna, in association with each other. More specifically, in the case of the fourth embodiment, the selected antenna storage unit 138 stores calculated values of n1, n2, n3, and times when these values are calculated.

As explained in the fourth embodiment, the selection controller 124a has a function of selecting three receiving antennas 7 in order of descending receiving strength, from the receiving antennas 7a to 7h, to detect a position. Because the capsule endoscope 2 sequentially moves within the subject 1, a receiving antenna 7 that receives a radio signal having high received strength also changes along the move of the capsule endoscope 2. Therefore, in the moving-state calculating device 136, the selection controller 124a performs an antenna selecting operation at each predetermined time. Based on the selecting operation performed at each predetermined time, the moving-state calculating device 136 can perform a receiving operation via the receiving antenna 7 suitable to receive a radio signal transmitted from the capsule endoscope 2, according to a move of the capsule endoscope 2. The selected antenna storage unit 138 stores a result of the antenna selecting operation repeatedly performed by the selection controller 124a to achieve the above object, and a time when the antenna selecting operation is performed. Through this storage operation, the selected antenna storage unit 138 stores the history of the receiving antennas 7 selected by the selection controller 124a, and supplies the stored information to the state determining unit 137d in the determining operation described later.

The state determining unit 137d has a function of determining a moving state of the capsule endoscope 2 based on a continuous selection time of a selected antenna stored in the selected antenna storage unit 138, unlike the state determining unit 124d according to the fourth embodiment. Specifically, the state determining unit 137d has a function of determining that the moving state of the capsule endoscope 2 is a normal state or a low-speed state, according to a length of the continuous selection time during which the same receiving antenna 7 is selected.

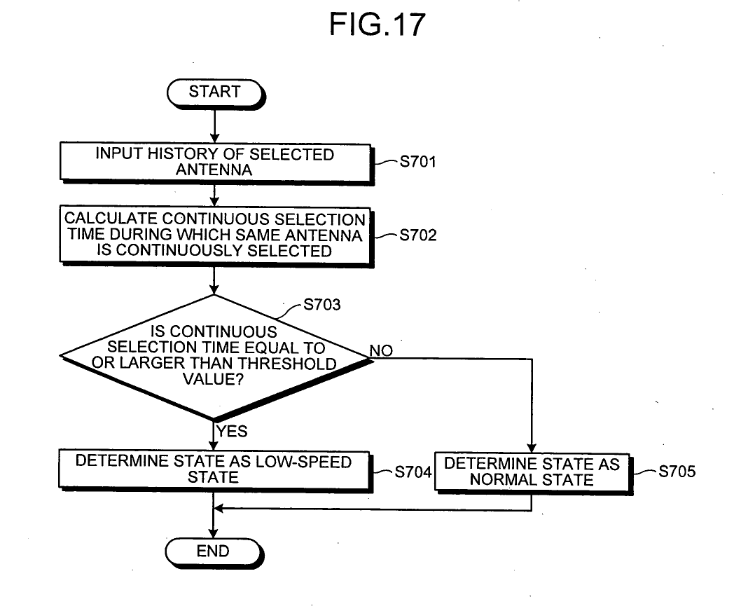

A determining operation performed by the state determining unit 137d is explained. FIG. 17 is a flowchart for explaining the determining operation performed by the state determining unit 137d, and the operation performed by the state determining unit 137d is explained below with reference to FIG. 17.

First, the state determining unit 137d inputs a history of selected antennas that are stored in the selected antenna storage unit 138 (step S701), and calculates a continuous selection time during which the same receiving antenna 7 is continuously selected (step S702). The state determining unit 137d determines whether the calculated continuous selection time is equal to or larger than a threshold value (step S703). When the calculated continuous selection time is equal to or larger than the threshold value (step S703, Yes), the state determining unit 137d determines that the moving state of the capsule endoscope 2 is a low-speed state (step S704). When the calculated continuous selection time is smaller than the threshold value (step S703, No), the state determining unit 137d determines that the moving state of the capsule endoscope 2 is a normal state (step S705).

A mechanism of a determining operation of a moving state using a continuous selection time is explained. As already explained, the selection controller 124a selects three receiving antennas 7 having high received strength of radio signals transmitted from the capsule endoscope 2, from the viewpoint of receiving a radio signal in a better condition. On the other hand, as explained in the fourth embodiment, a radio signal transmitted from the capsule endoscope 2 has a characteristic that the radio signal is gradually attenuated when a distance from the capsule endoscope 2 becomes longer. Therefore, strength of radio signals that are received via the receiving antennas 7a to 7h reflect a distance between each of the receiving antennas 7a to 7h and the capsule endoscope 2.

Therefore, the receiving antenna 7 that is selected by the selection controller 124a is not only a receiving antenna which is most suitable to receive a radio signal but also a receiving antenna which is nearest to the capsule endoscope 2. Accordingly, when the same receiving antenna 7 is selected in plural antenna-selecting operations, it can be estimated that the position of the capsule endoscope 2 within the subject 1 makes little change. When selected receiving antennas 7 are frequently changed over, it can be estimated that the capsule endoscope 2 is moving at a certain speed within the subject. As explained above, there is a correspondence between the selection history of receiving antennas 7 and the moving state of the capsule endoscope 2. Therefore, in the fifth embodiment, a moving state of the capsule endoscope 2 is detected based on a selection history of receiving antennas 7, in other words, based on the continuous selection time during which the same receiving antenna 7 is continuously selected.

By employing the above configuration, a moving-state detecting system having a simple configuration can be achieved. In other words, in the capsule endoscope system having plural receiving antennas provided at the outside of the subject 1, it is general that a receiving antenna is selected based on received strength. There are many systems that have configurations similar to those of the selection controller 124a and the antenna selector 121 according to the fifth embodiment. Therefore, the moving-state detecting system according to the fifth embodiment can be achieved by additionally providing a mechanism that stores a selection history of receiving antennas and a mechanism that determines a moving state of the capsule endoscope based on the stored selection history, in the conventional capsule endoscope system having a selection controller and the like. As explained above, the moving-state detecting system according to the fifth embodiment has the advantage that the system can be easily configured, in addition to the advantage explained in the fourth embodiment.

While the present invention has been explained above with reference to the first to the fifth embodiments, the present invention does not need to be interpreted as being limited to the above embodiments, and those skilled in the art can conceive various embodiments and modifications. For example, while a radio signal is used as an example of a sensor signal in the first to the fifth embodiments, the sensor signal in the claims do not need to be interpreted as being limited to the radio signal. For example, a permanent magnet can be disposed in the capsule endoscope 2, and a moving state of the capsule endoscope 2 can be detected through detection of strength of a static magnetic field formed by the permanent magnet. Specifically, the static magnetic field has a characteristic of being attenuated according to a distance from the source of occurrence. Therefore, the static magnetic field can be also used as a sensor signal in the claims, similarly to the radio signal. Other signal that is attenuated according to a distance can be also used as a sensor signal.

In the first to the fifth embodiments, the state determining units 24c, 33b, 36b, 124d, 137d determine either a normal state or a low-speed state as a moving state. However, a moving state detected in the present invention does not need to be interpreted as being limited to these states. For example, at least one moving state of a high-speed state, a normal state, a low-speed state, and a stationary state can be detected, with the use of one or more threshold values.

Further, in the first to the fifth embodiments, each of the moving-state calculating devices 8, 31, 35, 108, 136 has a configuration that performs processes up to the determination of a moving state, and the display device 4 is separately and individually configured. However, the moving-state calculating device 8 or the like and the display device 4 can be integrally configured. Alternatively, a state determining unit can be provided in the display device 4. The number of receiving antennas 7 in the first and the third embodiments does not need to be limited to eight, and can be an optional number.

### INDUSTRIAL APPLICABILITY

As described above, the moving-state detecting apparatus and the moving-state detecting system according to the present invention are useful for an intra-subject detecting apparatus and an intra-subject detecting system that detect a moving state of a body-insertable apparatus which moves within the subject and outputs a sensor signal attenuated according to a distance within the subject. Particularly, the moving-state detecting apparatus and the moving-state detecting system according to the present invention are useful for an intra-subject detecting apparatus and an intra-subject detecting system that detect a moving state of the capsule endoscope as a body-insertable apparatus.

1. A moving-state detecting apparatus that detects a moving state of a body-insertable apparatus that moves within a subject, and outputs a sensor signal which is attenuated according to a propagation distance inside the subject, the moving-state detecting apparatus comprising:
a receiving antenna unit that receives the sensor signal; and
a moving-state calculator that calculates a moving state of the body-insertable apparatus, based on received strength of the sensor signal received by the receiving antenna unit.

2. The moving-state detecting apparatus according to claim 1, wherein
a plurality of the receiving antenna units are disposed, and
the moving-state calculator comprises
an antenna selector that selects one or more receiving antenna units from the plurality of the receiving antenna units at each predetermined time interval, based on received strength of the sensor signal;
a timing unit that measures a time during which the antenna selector continuously selects the same receiving antenna unit; and
a determining unit that determines a moving state of the body-insertable apparatus, based on a time measured by the timing unit.

3. The moving-state detecting apparatus according to claim 2, wherein
when the time measured by the timing unit is equal to or above a predetermined threshold value, the determining unit determines that a moving state of the body-insertable apparatus is in a low-speed state.

4. The moving-state detecting apparatus according to claim 1, wherein
the body-insertable apparatus has a function of transmitting a radio signal as the sensor signal, and
the moving-state calculator calculates a moving state of the body-insertable apparatus, based on the strength of a radio signal from the body-insertable apparatus received by the receiving antenna unit.

5. The moving-state detecting apparatus according to claim 1, wherein
the moving-state calculator calculates a moving state of the body-insertable apparatus, based on a change rate of received strength of the sensor signal received by the receiving antenna unit.

6. The moving-state detecting apparatus according to claim 1, wherein
a plurality of the receiving antenna units are disposed, and
the moving-state calculator calculates a moving state of the body-insertable apparatus, based on a change of received strength received by each of the plural receiving antenna units.

7. The moving-state detecting apparatus according to claim 1, wherein
the moving-state calculator comprises
a position calculator that calculates a position of the body-insertable apparatus, based on received strength received by the receiving antenna unit; and
a state determining unit that determines a moving state of the body-insertable apparatus, based on a change rate of a position of the body-insertable apparatus calculated by the position calculator.

8. The moving-state detecting apparatus according to claim 7, wherein
the state determining unit calculates a change rate, based on a position of the body-insertable apparatus calculated at a plurality of different times by the position calculator.

9. The moving-state detecting apparatus according to claim 2, wherein
the antenna selector selects a predetermined number of the receiving antenna units in order of the descending received strength, and
the timing unit measures a time during which a size relationship of received strength of the receiving antenna units that are selected simultaneously remains the same, as a continuation selection time.

10. A moving-state detecting system comprising a body-insertable apparatus that is inserted into a subject, acquires predetermined intra-subject information, and performs radio-transmission of a radio signal including the intra-subject information to the outside; and a moving-state detecting apparatus that receives the radio signal transmitted from the body-insertable apparatus, and calculates a moving state of the body-insertable apparatus, wherein
the body-insertable apparatus includes
a sensor signal transmitter that transmits a sensor signal which is attenuated according to a propagation distance, and
the moving-state detecting apparatus includes
a receiving antenna unit that receives the sensor signal, and
a moving-state calculator that calculates a moving state of the body-insertable apparatus, based on received strength of the sensor signal received by the receiving antenna unit.

11. The moving-state detecting system according to claim 10, wherein
the moving-state detecting apparatus includes a plurality of the receiving antenna units, and
the moving-state calculator includes
an antenna selector that selects one or more receiving antenna units from the plurality of the receiving antenna units, based on received strength of the sensor signal;
a timing unit that measures a time during which the antenna selector continuously selects the same receiving antenna unit; and
a determining unit that determines a moving state of the body-insertable apparatus, based on a time measured by the timing unit.

12. A moving-state detecting system comprising a body-insertable apparatus that is inserted into a subject, acquires predetermined intra-subject information, and performs radio-transmission of a radio signal including the intra-subject information to the outside; and a moving-state detecting apparatus that receives the radio signal transmitted from the body-insertable apparatus, and calculates a moving state of the body-insertable apparatus, wherein
the body-insertable apparatus includes
a sensor signal transmitter that transmits a sensor signal which is attenuated according to a propagation distance, and
the moving-state detecting apparatus includes
a receiving antenna unit that receives the sensor signal,
a position calculator that calculates a position of the body-insertable apparatus, based on received strength received by the receiving antenna unit, and
a state determining unit that determines a moving state of the body-insertable apparatus, based on a change rate of a position calculated by the position calculator.

13. The moving-state detecting system according to claim 10, wherein
the moving-state detecting apparatus further includes
an intra-subject information acquiring unit that acquires predetermined intra- subject information inside the subject, and
the sensor signal transmitter transmits a radio signal including the intra-subject information as a sensor signal, and
the moving-state detecting apparatus further includes
an information extracting unit that extracts the intra-subject information from a radio signal received via the receiving antenna unit.

14. The moving-state detecting system according to claim 12, wherein
the moving-state detecting apparatus further includes
an intra-subject information acquiring unit that acquires predetermined intra- subject information inside the subject, and
the sensor signal transmitter transmits a radio signal including the intra-subject information as a sensor signal, and
the moving-state detecting apparatus further includes
an information extracting unit that extracts the intra-subject information from a radio signal received via the receiving antenna unit.

15. The moving-state detecting system according to claim 13, further comprising a display device that displays the intra-subject information and a moving state of the body-insertable apparatus near a position where at least the intra-subject information is acquired.

16. The moving-state detecting system according to claim 14, further comprising a display device that displays the intra-subject information and a moving state of the body-insertable apparatus near a position where at least the intra-subject information is acquired.

17. The moving-state detecting apparatus according to claim 1, wherein
the moving-state calculator detects one of the moving states of a high-speed state, a normal state, a low-speed state, and a stationary state, using one or more threshold values.

18. The moving-state detecting system according to claim 15, wherein
the display device displays the intra-subject information in an image display area, and displays the moving state of the body-insertable apparatus in a state display area, and
a schematic subject image is displayed in the state display area, and a schematic passing route of the body-insertable apparatus is displayed in the schematic subject image; a state of moving speed of the body-insertable apparatus is displayed on the passing route through which the body-insertable apparatus moves; and a position near a position where the intra-subject information displayed in the image display area is acquired is displayed on the passing route.

19. The moving-state detecting system according to claim 16, wherein
the display device displays the intra-subject information in an image display area, and displays the moving state of the body-insertable apparatus in a state display area, and
a schematic subject image is displayed in the state display area, and a schematic passing route of the body-insertable apparatus is displayed in the schematic subject image; a state of moving speed of the body-insertable apparatus is displayed on the passing route through which the body-insertable apparatus moves; and a position near a position where the intra-subject information displayed in the image display area is acquired is displayed on the passing route.

20. The moving-state detecting system according to claim 15, wherein the display device is provided in the moving-state detecting apparatus.

21. The moving-state detecting system according to claim 16, the display device is provided in the moving-state detecting apparatus.

22. The moving-state detecting system according to claim 15, wherein the display device is a standalone workstation.

23. The moving-state detecting system according to claim 16, wherein the display device is a standalone workstation.

24. The moving-state detecting system according to claim 23, wherein the display device is provided in the moving-state detecting apparatus, and in the standalone workstation.

25. The moving-state detecting system according to claim 24, wherein the display device is provided in the moving-state detecting apparatus, and in the standalone workstation.
